(19) United States
(12) Patent Application Publication
(10) Pub. No.: US 2026/0003978 A1
(43) Pub. Date: Jan. 1, 2026

(54) TECHNIQUES FOR A PHYSICAL SIDE-CHANNEL-RESILIENT ARTHMETIC LOGIC UNIT

(71) Applicant: Intel Corporation, Santa Clara, CA (US)

(72) Inventors: Santosh GHOSH, Hillsboro, OR (US); Dumitru-Daniel DINU, Chandler, AZ (US); Joseph FRIEL, Chandler, AZ (US); Avinash L. VARNA, Chandler, AZ (US); Manoj R. SASTRY, Portland, OR (US)

(21) Appl. No.: 18/758,577

(22) Filed: Jun. 28, 2024

(51) Int. Cl. G06F 21/60; G06F 21/64

(52) U.S. Cl. CPC G06F 21/602; G06F 21/64

(57) ABSTRACT

Examples include techniques for a physical side-channel resilient arithmetic logic unit (ALU) The examples include use of circuitry to input a shared representation of a value having a plurality of shares to the ALU. Then, at the ALU, recombine the shared representation of the value to a single representation of the value and use the single representation to generate a result value or operate on the shared representation of the value to generate a shared representation of the result value. If the result value is based on operating on the single representation of the value, the result value is split to a shared representation of the result value. The shared representation of the result value can be output from the ALU and stored to at least one register from among a plurality of registers.

### TECHNICAL FIELD

Examples described herein are generally related to techniques associated with circuitry and/or techniques implemented to provide protection from physical side-channel attacks that attempt to obtain secrete values used for cryptography algorithm operations that are executed in an arithmetic logic unit.

### BACKGROUND

Communication protocols may rely on core cryptographic functionalities that include public key encryption, digital signatures, and key exchange. A quantum computer is a machine that exploits quantum mechanical phenomena to solve mathematical problems that are difficult or intractable for conventional computes and can break many public-key cryptosystems that are currently in use. Post-Quantum Cryptograph (PQC) likely will soon replace existing public-key algorithms for use with products that implement communication protocols that rely on cryptographic functionalities. An important factor for a successful PQC deployment will include security implementations against physical side-channel attacks.

### BRIEF DESCRIPTION OF THE DRAWINGS

FIG. 1 illustrates an example computing system.

FIG. 2 illustrates an example countermeasure control circuitry.

FIG. 3 illustrates an example protection scheme.

FIG. 4 illustrates an example first process implemented by countermeasure control circuitry.

FIG. 5 illustrates an example second process implemented by countermeasure control circuitry.

FIG. 6 illustrates an example logic flow.

FIG. 7 illustrates an example computing system.

FIG. 8 illustrates a block diagram of an example processor and/or System on a Chip (SoC) that may have one or more cores and an integrated memory controller.

FIG. 9 is a block diagram illustrating a computing system 900 configured to implement one or more aspects of the examples described herein.

FIG. 10A illustrates examples of a parallel processor.

FIG. 10B illustrates examples of a block diagram of a partition unit.

FIG. 10C illustrates examples of a block diagram of a processing cluster within a parallel processing unit.

FIG. 10D illustrates examples of a graphics multiprocessor in which the graphics multiprocessor couples with the pipeline manager of the processing cluster.

FIGS. 11A-11C illustrate additional graphics multiprocessors, according to examples.

FIG. 12 shows a parallel compute system 1200, according to some examples.

FIGS. 13A-13B illustrate a hybrid logical/physical view of a disaggregated parallel processor, according to examples described herein.

FIG. 14A is a block diagram illustrating both an example in-order pipeline and an example register renaming, out-of-order issue/execution pipeline according to examples.

FIG. 14B is a block diagram illustrating both an example in-order architecture core and an example register renaming, out-of-order issue/execution architecture core to be included in a processor according to examples.

FIG. 15 illustrates examples of execution unit(s) circuitry, such as execution unit(s) circuitry.

FIG. 16 is a block diagram of a register architecture according to some examples.

FIG. 17 illustrates examples of an instruction format.

FIG. 18 illustrates examples of an addressing information field.

FIG. 19 illustrates examples of a first prefix.

FIGS. 20A-20D illustrate examples of how the R, X, and B fields of the first prefix are used.

FIGS. 21A-21B illustrate examples of a second prefix.

FIG. 22 illustrates examples of a third prefix.

FIGS. 23A-23B illustrate thread execution logic including an array of processing elements employed in a graphics processor core according to examples described herein.

FIG. 24 illustrates an additional execution unit, according to an example.

FIG. 25 is a block diagram illustrating a graphics processor instruction formats 2500 according to some examples.

FIG. 26 is a block diagram of another example of a graphics processor.

FIG. 27A is a block diagram illustrating a graphics processor command format according to some examples.

FIG. 27B is a block diagram illustrating a graphics processor command sequence according to an example.

FIG. 28 is a block diagram illustrating the use of a software instruction converter to convert binary instructions in a source ISA to binary instructions in a target ISA according to examples.

FIG. 29 is a block diagram illustrating an IP core development system 2900 that may be used to manufacture an integrated circuit to perform operations according to some examples.

### DETAILED DESCRIPTION

The present disclosure relates to techniques for side-channel countermeasures to increase resiliency of an arithmetic logic unit (ALU) used as cryptographic execution circuitry from physical side-channel attacks or analysis (SCA). Examples herein are directed to countermeasure circuitry for mitigating fault injection, and/or power and/or electromagnetic field related attacks on cryptography, such as, but not limited to, cryptography according to a Fast Fourier lattice-based compact signatures over NTRU (e.g., “FALCON”) encryption standard. In certain examples, an encryption standard (e.g., Falcon) is a lattice-based signature scheme, e.g., standardized by the National Institute of Standards and Technology (NIST). Compared to other post-quantum cryptography (PQC) signature schemes, in certain examples, a lattice-based signature scheme (e.g., Falcon) is suitable for low bandwidth applications (such as internet-of-things (IoTs) devices) due to its relatively smaller public key and signature compared to other PQC encryption algorithms. Unlike other PQC algorithms, certain examples of a lattice-based signature scheme (e.g., Falcon) use a Fast Fourier trapdoor sampler, floating point arithmetic, and a Falcon tree. With the industry starting to transition from existing public key algorithms to PQC, security of implementations against physical attacks is an important criterion for secure PQC deployment.

However, some technical problems are that (i) certain lattice-based signature schemes (e.g., Falcon) utilize unprotected implementations that are vulnerable to physical attacks such as side-channel and fault injection analysis technique, (ii) Fast Fourier sampling (ffSampling) is the most complex operation of generating a signature (e.g., Falcon signing (Sign)), but protecting ffSampling against SCA and fault injection (FI) attacks can be challenging due to the floating-point arithmetic and Gaussian sampling, (iii) application of state-of-the-art countermeasures like masking to the entire algorithm can be challenging and expected to have a large overhead (e.g., die area) due to its complexity, and (iv) protecting software or imbedded implementations of PQC against SCA or FI attacks can be difficult due a relatively large code size and possibly unacceptably high execution time overheads.

To overcome these technical problems, examples herein describe techniques to utilize countermeasure control circuitry to provide a physical side-channel resilient ALU that can prevent or reduce side-channel attacks (e.g., via SCA on power, electro-magnetic (EM), photon emission, etc.) on fundamental operations (e.g., generating cryptographic signatures) associated with PQC algorithms and enable protection of software implementations against these attacks at a relatively low implementation complexity and overhead when compared to traditional masking countermeasures. As described more below, these techniques can include protection of data during execution of a cryptographic operation via a splitting of each sensitive variable into random, multiple secret shares or shared representations that are provided to an ALU and then recombined at the ALU or directly operated on at the ALU for a cryptographic operation/computation. If recombined at the ALU, respective results/computations can then split again before leaving the ALU. The techniques can also include protecting data casting that involves blinding a conversion of a sign for an m-bit integer to a floating point representation. The blinding of the conversion can reduce or eliminate relatively high power/EM side-channel leakage due to a large Hamming distance for negative numbers in an integer and respective floating point representation. As described below, blinding techniques can include use of a randomly generated value to blind the conversion of a sign of the m-bit integer to a floating point representation.

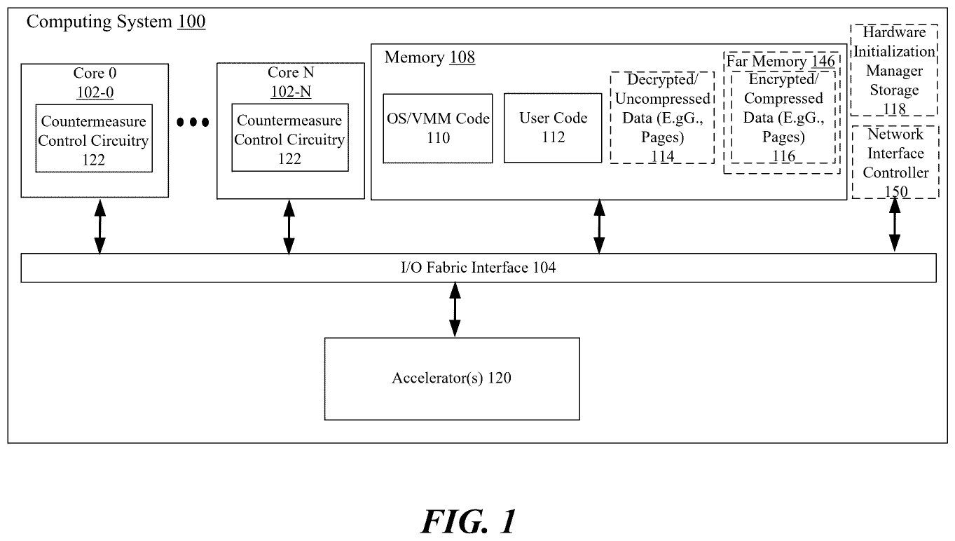

FIG. 1 illustrates an example computing system 100. In some examples, computing system 100 can include one or more cores 102-0 to 102-N (e.g., where N is any positive integer greater than one, although single core examples may also be utilized). Cores 102-0 to 102-N can represent processing elements of a multi-core processor, a multi-core graphics processing unit (GPU), an accelerator or a field programmable graphics array (FPGA). As described in more detail below, one or more cores included in cores 102-0 to 102-N can include countermeasure control circuitry 122 that can be configured to provide protection of data during execution of a cryptographic operation (e.g., by an ALU) associated with a PQC algorithm (e.g., a FALCON algorithm) to prevent or reduce impacts (e.g., leakage) from physical side-channel attacks.

In some examples, as shown in FIG. 1, computing system 100 can also include a memory 108, a hardware initialization manager storage 118, a network interface controller 150, or one or more accelerator(s) 120 that can be arranged to couple with cores 102-0 to 102-N via an input/output (I/O) interface 104. Also, as shown in FIG. 1, in some examples, memory 108 can include an operating system (OS) and/or virtual machine monitor code 110, user (e.g., program) code 112, decrypted (e.g., and uncompressed) data (e.g., pages) 114, encrypted (e.g., and compressed) data (e.g., pages) 116, or any combination thereof. In some examples of computing, a virtual machine (VM) is an emulation of a computer system. In certain examples, VMs are based on a specific computer architecture and provide the functionality of an underlying physical computer system. Their implementations may involve specialized hardware, firmware, software, or a combination. In certain examples, the virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (I/O) resources, such as, but not limited to, an input/output memory management unit (IOMMU). The VMM may provide a centralized interface for managing the entire operation, status, and availability of VMs that are installed over a single host machine or spread across different and interconnected hosts.

According to some examples, memory 108 may be memory separate from a multi-core processor, GPU, accelerator, or FPGA that includes cores 102-0 to 102-N. For these examples, memory 108 can include volatile (e.g., DRAM) or non-volatile (e.g., NAND) types of memory. Encrypted data 116 can be stored in a first memory device (e.g., far memory 146) and/or decrypted data 114 can be stored in a separate, second memory device (e.g., as near memory). Encrypted data 116 and/or decrypted data 114 can be in a different computing system 100, e.g., as accessed via network interface controller 150.

A coupling via I/O fabric interface 104 can allow communication between accelerator(s) 120, core(s) 102-0 to 102-N, memory 108, hardware initialization manager storage 118, network interface controller 150, or any combination thereof. In some examples, at least a portion of I/O fabric interface 104 can be configured to operate in compliance with one or more compute express link (CXL) specifications published by the CXL Consortium to included, but not limited to, CXL Specification, Rev. 2.0, Ver. 1.0, published in October 2020, or CXL Specification, Rev. 3.1, published in August 2023.

In some examples, the hardware initialization manager (non-transitory) storage 118 can store hardware initialization manager firmware (e.g., or software). For example, hardware initialization manager (non-transitory) storage 118 can store Basic Input/Output System (BIOS) firmware. In another example, hardware initialization manager (non-transitory) storage 118 can stores Unified Extensible Firmware Interface (UEFI) firmware. According to some examples (e.g., triggered by the power-on or reboot of a processor), computing system 100 (e.g., core 102-0) executes the hardware initialization manager firmware (e.g., or software) stored in hardware initialization manager (non-transitory) storage 118 to initialize computing system 100 for operation, for example, to begin executing an OS and/or initialize and test the (e.g., hardware) components of computing system 100.

An accelerator 120 may include any of the depicted components. In certain examples, accelerator 120 receives a (e.g., offload) job from a core. The job, for example, can include, but is not limited to a cryptographic job, a storage acceleration job, a graphics or video processing job, a packet processing job, a machine learning job or an artificial intelligence inference job.

Although not shown in FIG. 1, in some examples, computing system 100 can be arranged to couple with or have an integrated storage unit, e.g., an internal or external solid state drive or hard drive.

According to some examples, computing system 100 can be included in a system-on-a-chip (SoC). An SoC is a term often used to describe a device or system having a compute elements and associated circuitry (e.g., I/O circuitry, power delivery circuitry, memory controller circuitry, memory circuitry, etc.) integrated monolithically into a single integrated circuit (“IC”) die, or chip. For example, a device, computing platform or computing system could have one or more compute elements (e.g., cores) and associated circuitry (I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

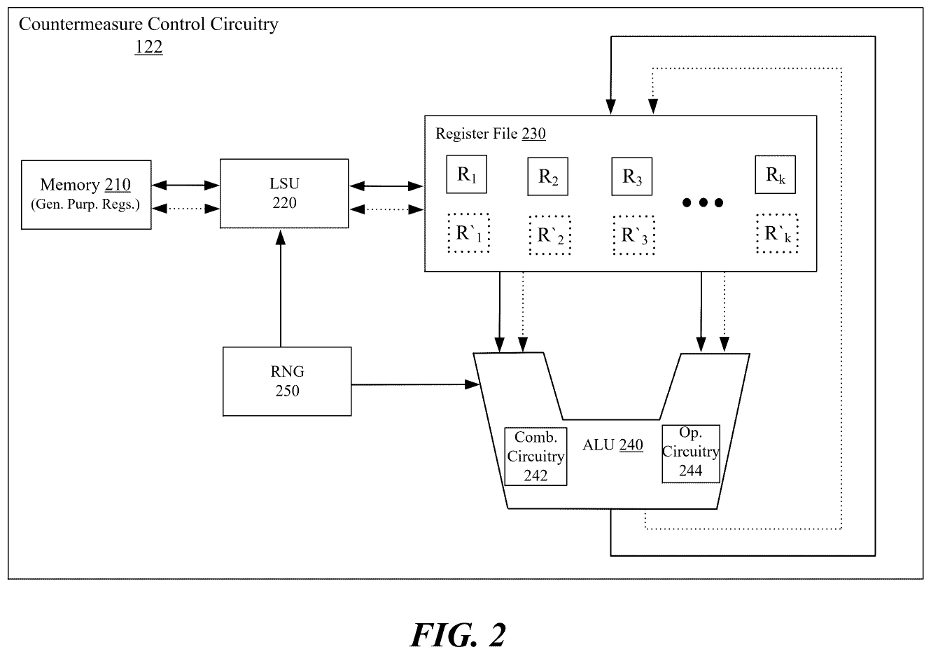

FIG. 2 illustrates an example of countermeasure control circuitry 122. According to some examples, as shown in FIG. 2 countermeasure control circuitry 122 includes a memory 210 (e.g., general purpose registers), a load storage unit (LSU) 220, a register file 230, an arithmetic logic unit (ALU) 240 and a random number generator (RNG) 250. For these examples, the logic and/or features of countermeasure control circuitry 122 can be arranged to protect up to m-bit variables (e.g., 32-bit variables) either loaded from or stored to memory 210 by LSU 220 as these m-bit variables are input to or output from/to ALU 240 via register file 230. The m-bit variables, for example, can be shared representations of either an input value (e.g., secret key) to be operated on by logic and/or features at ALU 240 such as operation circuitry 244 or an output value (e.g., cryptographic signature) generated in association with a cryptographic operation.

According to some examples, each m-bit variable can either be stored to memory 210 as a shared representation or converted to a shared representation by LSU 220 before loading to register file 230. The m-bit variables can be either stored in or convert to shared representations using n (n≥2) shares. If, for example, a secret value is identified as “x” and the shared representations are to later be recombined using a Boolean XOR operation at ALU 240, then x=x1\hat{ }x2\hat{ } . . . \hat{ }xn and these shared representations can be referred to as n Boolean shares. If the shared representations are to later be recombined using an arithmetic addition operation at ALU 240, then x=x1+x2+ . . . +xn and these shared representations can be referred to as n arithmetic shares. Also, x1, x2, . . . xn−1 can be arranged as m-bit randomly generated values. For example, for n=2 shared representations, instead of LSU 220 loading x to register file 230, separate m-bit values for x1 and x2 can be loaded by LSU 220 to register file 230 and separately input to ALU 240. In some examples, n Boolean shares or n arithmetic shares can be recombined at ALU 240 back to the single representation of x using combinatorial circuitry logic and/or features such as combination circuitry 242. For these examples, operation circuitry 244 at ALU 240 can then execute an operation (e.g., cryptographic operation) on the single representation x to generate a value y result. The value y result can then be split by combination circuitry 242 to n=2 shared representations of y1 and y2 and then y1 and y2 are outputted by ALU 240 to register file 230 for eventual storage in memory 210 through LSU 220. In other examples, rather than recombine the n Boolean shares or n arithmetic shares, combinatorial circuitry, logic and/or features such as combination circuitry 242 can be configured to operate directly on a shared representation and to output a shared representation y1 and y2 result. Hence, for these other examples, combination circuitry 242 is not used. These data protection measures, as well as protecting integer to floating point representation casting (described more below), can significantly reduce a risk of leakage (e.g., power, EM, photo emission, etc.) of memory and register operations (e.g., loads and stores), which can be a major target of physical side-channel analysis attacks.

In some examples, a number of shares n included in share representations of a secret value such as a secret value represented by x, can be configured at design time of countermeasure control circuitry 122 to be included in one or more processing elements such as a core from among cores 102-0 to 102-N. For example, two share representations of an input x of x1 and x2 to be input to ALU 240 can be loaded from a register pair Rᵢ maintained in memory 210 and Rᵢ for 1≤i≤k, where k is a total number of registers (e.g., general purpose registers) maintained in memory 210 or LSU 220 can be configured to covert a value stored in memory 210 to a shared representations prior to loading to R, of register file 230. Also, two shared representations of an output y of y1 and y2 to be output from ALU 240 can be stored to a register pair Ri maintained in memory 210 or LSU can be configured to convert the two shared representations of output y1 and y2 to a single representation of output y and then store the single representation of output y to memory 210. As shown in FIG. 2, the solid-line arrow input to the left side of ALU 240 can represent an input x1 from R₁ and the dotted-line arrow input to the left side of ALU 240 can represent an input x2 from R′₁. Also, the solid-line arrow input to the right side of ALU 240 can represent a first share of a second shared representation input, for example, from R₂ and the dotted-line arrow input to the right side of ALU 240 can represent a second share of the second shared representation input, for example, from R′₂. Also, as shown in FIG. 2, the solid-line arrows from ALU 240 can represent an output y1 to be stored to R₃ and the dotted-line arrows from ALU 240 can represent an output y2 to be stored to R′₃.

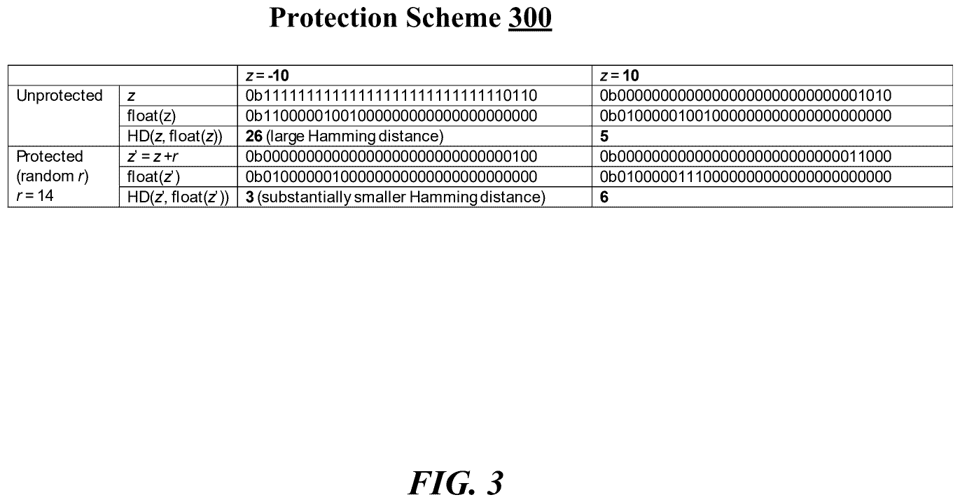

FIG. 3 illustrates an example protection scheme 300. According to some examples, protection scheme 300 can be implemented to protect data casting when casting a signed secret value from an m-bit integer (e.g., “z”) to a floating point representation (e.g., “f”), where m is any whole, positive number. The signed secret value can be generated by logic and/or features of an ALU such as operation circuitry 244 of ALU 240 as part of a cryptographic operation. Casting of an integer to a floating point representation (e.g., operation z−f) can cause leakage of an integer's sign through power/EM physical side-channels due to a large Hamming distance associated with negative number integers and respective floating point representations.

For the example protection scheme 300 shown in FIG. 3, an example secret 32-bit integer value of “z” is shown for both a negative number integer of −10 and a positive number integer of 10. For these examples, in an unprotected state (e.g., float(z)−f), can include a casting of a −10 for z in binary to float(z) for an m=32 or 32-bit value that results in a need to flip 26 bits, which represents a large Hamming distance (examples are not limited to m=32 or 32-bit values). Comparatively, also in an unprotected, state, a casting of a 10 for z in binary to float(z) for the 32-bit value that results in a need to only flip 6 bits. In a protected state, a conversion of the sign of a −10 for z can be made blind via use of a random integer r, such that z+r>0. For example, the operation of z−f can be performed as float(z+r)−f−float(r). So, in the protected state, using a randomly generated value of r=14 (e.g., generated by RNG 250), the casting of −10+14=4 in binary to float(z′) results in a need to only flip 3 bits, which is substantially smaller Hamming distance when compared to the Hamming distance of 26 when integer z was unprotected. Meanwhile the protected state of z=10 has only a minor increase in Hamming distance from 5 to 6.

In another example of blinding a casting of a signed secret value (not shown in FIG. 3), consider i and r as two integers and f is a floating point representation. For this other example, an operation of i*f can be computed as (float(i+r)*f)−(float(r)*f) instead of a traditional execution of the operation of float(i)*f.

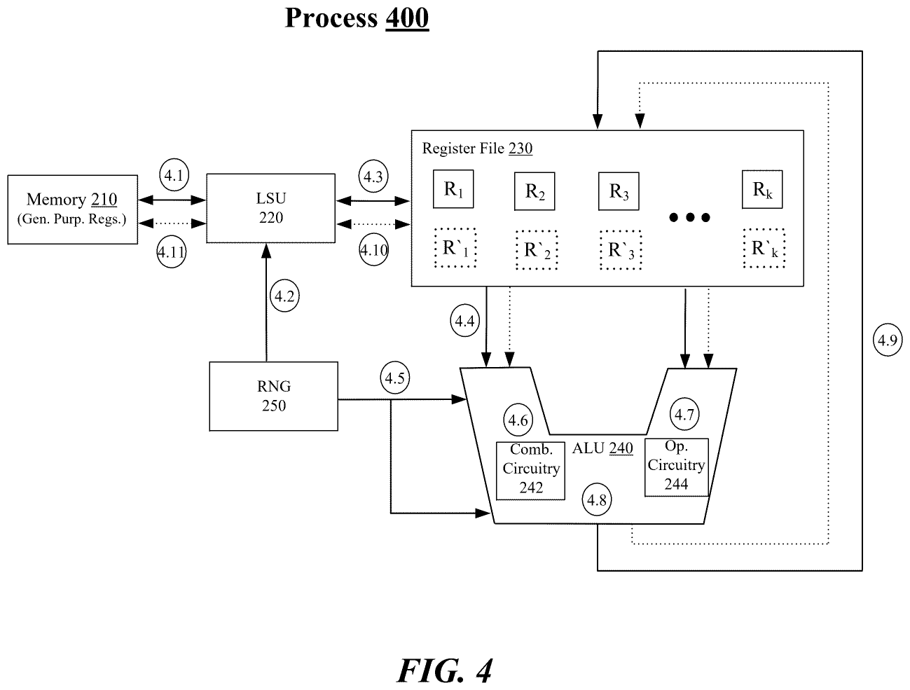

FIG. 4 illustrates an example process 400. According to some examples, process 400 depicts an example implementation of techniques to utilize countermeasure control circuitry such as countermeasure control circuitry 122 to provide a physical side-channel resilient ALU (e.g., ALU 240) as part of that utilized countermeasure control circuitry. For these examples, a share representation of a value x can be based on n=2 shares. Although examples are not limited to n=2 shares, any number of shares greater than 2 are also contemplated.

According to some examples, at 4.1, a shared representation of a value x can be loaded by LSU 220 from a register pair maintained in memory 210. For these examples, the shared representation of x can be m-bit (e.g., 32-bit) values of x1 and x2, and a first register of the register pair can be configured to store x1 and a second register of the register pair can be configured to store x2. In other examples, the value x can be stored in a single register maintained in memory 210 and LSU 220 can be configured to convert the value x to a shared representation of x1 and x2.

In some examples, at 4.2, if LSU is to convert the value x to the shared representation of x1 and x2, RNG 250 can be configured to provide a random number to be used to convert the value x to form the shared representation of x1 and x2. For example, x1 can be the provided randomly generated value and x2=x\hat{ }x1 or x+x1. For these examples, RNG 250 can be configured as either a pseudo random number generator or a true random number generator to provide random numbers.

According to some examples, at 4.3, LSU 220 can cause x1 and x2 to be loaded to register file 230 corresponding to registers R₁ for loading x1 and R′₁ for loading x2.

In some examples, at 4.4, the shared representation of x1 and x2 are input to ALU 240.

According to some examples, at 4.5, RNG 250 can also provide the random number provided to LSU 220 at 4.2 to ALU 240 if LSU 220 formed x1 and x2 and/or can provide a fresh random number if the random number was not used to form x1 and x2. For examples where LSU 220 formed x1 and x2 and where x1 and x2 are to be recombined prior to operation circuitry 244 receiving a single representation of value x, combination circuitry 242 can remove random number x1 from x2 to recombine x1 and x2 back to a single representation of value x based on x=x1\hat{ }x2.

In some examples where x1 and x2 are to be recombined to a single representation of value x, at 4.6, combination circuitry 242 can combine x1 and x2 to cause the shared representation of the value x to be recombined to a single representation of value x. For example, if x1 and x2 are Boolean shares, then the shared representation of value x is recombined by x=x1\hat{ }x2 to generate an XOR result based on the 2 operands of x1 and x2. For this example, the XOR result is to be the single representation of value x. In another example, if x1 and x2 are arithmetic shares, then the shared representation of value x is recombined by x=x1+x2 to generate an addition result based on the 2 operands of x1 and x2. For this other example, the addition result to be the single representation of value x.

According to some examples, at 4.7, operation circuitry 244 can use the single representation of value x in an operation to generate a value y result. The operation, for example, can be a cryptographic operation that uses either the single representation of value x to generate a cryptographic signature that is represented by value y result or operation circuitry 244 operates directly on shared representation x1 and x2 to generate a cryptographic signature that is represented by a shared representation value of y1 and y2. Also, in some examples, the random number provided at 4.5 by RNG 250 can also be used to blind a sign conversion if the single representation of value x or the shared representation x1 and x2 respectively have an m-bit integer value of z that is negative and is to be cast to a floating point representation prior to the cryptographic operation, provided that the random number, when added the m-bit integer value of z, results in a number greater than 0 as described above for protection scheme 300. If the random number does not result in a number greater than 0, then other random numbers can be obtained from RNG 250 until a random number is obtained that results in a number greater than 0.

In some examples where x1 and x2 are to be recombined to a single representation of value x, at 4.8, combination circuitry 242 can cause the value y result to be split to a shared representation based on n=2 shares. For example, if Boolean shares, then the value y result can be split such that y=y1\hat{ }y2 or if arithmetic shares, then y=y1+y2. In examples, where operation circuitry 244 operated directly on shared representation x1 and x2 to generate a cryptographic signature that is represented by a shared representation value of y1 and y2, no splitting is required.

According to some examples, at 4.9, the shared representation of the value y results that includes y1 and y2 is loaded to register file 230. For example, y1 is loaded to R₃ and y2 is loaded to R′₃.

In some examples, at 4.10, LSU 220 obtains y1 and y2 from R₂ and R′₂ at register file 230 and then, at 4.11, causes y1 and y2 to be stored to a register pair maintained in memory 210. In some other examples, LSU 220 can combine y1 and y2 to generate a single representation value of y and then store that value to a single register maintained in memory 210. Process 400 then comes to an end.

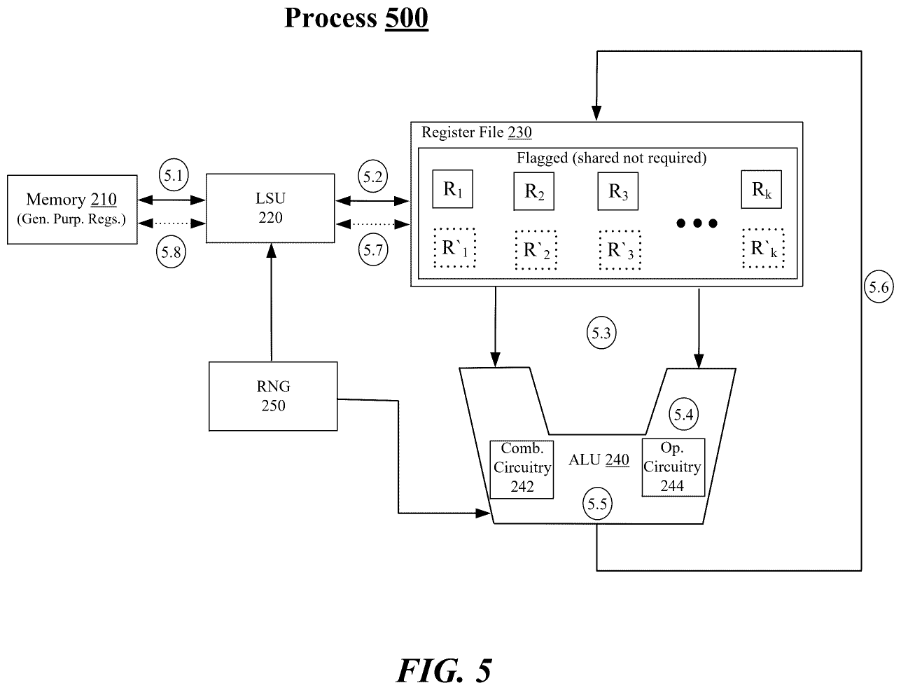

FIG. 5 illustrates an example process 500. According to some examples, process 500 depicts an example implementation of techniques to utilize countermeasure control circuitry such as countermeasure control circuitry 122 to provide a physical side-channel resilient ALU (e.g., ALU 240) as part of that utilized countermeasure control circuitry. However, different from process 400, process 500 is for when a shared representation of a value x is not required. For example, if the value x is not a secret key to be used in a cryptographic operation, but rather is public key to be used in a cryptographic operation. As a result, an instruction or command that initiates process 500 can include a flag to indicate that a shared representation of n shares is not required for the cryptographic operation. As a result of the flag, the first share of the n shares holds the actual value to be used in the cryptographic operation. For example process 500 a non-shared representation of a value x is stored to a register pair maintained in memory 210. Examples are not limited to storing the non-shared representation value x to a register pair. Similar to what is described for process 400, LSU 220 can be configured to convert a value x to a non-shared representation of the value x and then convert a non-shared representation result of y1 and y2 to a result value y to be stored to a single register maintained in memory 210. For simplicity purposes, the conversions the value x and the non-shared representation result of y1 and y2 are not described for process 500.

According to some examples, at 5.1, responsive to a flag indicating that a shared representation is not required, a non-shared representation of a value x can be loaded by LSU 220 from a register pair maintained in memory 210. For these examples, the non-shared representation can include n=2 shares x1 and x2 with x1 holding the actual value to be used in a cryptographic operation, while x2 can be set such that x=x1=x1\hat{ }x2 (if Boolean shares) or x=x1=x1+x2 (if arithmetic shares). Also, the non-shared representation of x can be m-bit (e.g., 32-bit) values of x1 and x2, and a first register of the register pair can be configured to store x1 and a second register of the register pair can be configured to store x2.

According to some examples, at 5.2, LSU 220 can cause x1 and x2 to be loaded to register file 230 corresponding to registers R₁ for loading x1 and R′1 for loading x2. For these examples, the non-shared representation of value x can be flagged to indicate that only x1 that was loaded to R₁ of register file 230 is needed for input to ALU 240 for a cryptographic operation.

In some examples, at 5.3, only x1 with the added random number is input to ALU 240.

According to some examples, at 5.4, operation circuitry 244 can use the single representation of value x in an operation to generate a value y result. The operation, for example, can be a cryptographic operation that uses the value x1 to generate cryptographic signature that is represented by value y result. Also, in some examples, a random number is provided by RNG 250 and the random number can be used to blind a sign conversion if the single representation of value x has an m-bit integer value of z that is negative and is to be cast to a floating point representation prior to the cryptographic operation, provided that the random number, when added the m-bit integer value of z, results in a number greater than 0 as described above for protection scheme 300. If the random number does not result in a number greater than 0, then other random numbers can be obtained from RNG 250 until a random number is obtained that results in a number greater than 0.

In some examples, at 5.5, operation circuitry 244 can cause the value y result to be split to a non-shared representation based on n=2 shares. For example, if Boolean shares, then the value y result can be split such that y=y1=y1\hat{ }y2 or if arithmetic shares, then y=y1=y1+y2.

According to some examples, at 5.6, the non-shared representation of the value y results that includes y1 and y2 is loaded to register file 230. For example, y1 is loaded to R₃ and y2 is loaded to R′₃.

In some examples, at 5.7, LSU 220 obtains y1 and y2 from R₃ and R′₃ at register file 230 and then, at 5.10, causes y1 and y2 to be stored to a register pair maintained in memory 210. Process 500 then comes to an end.

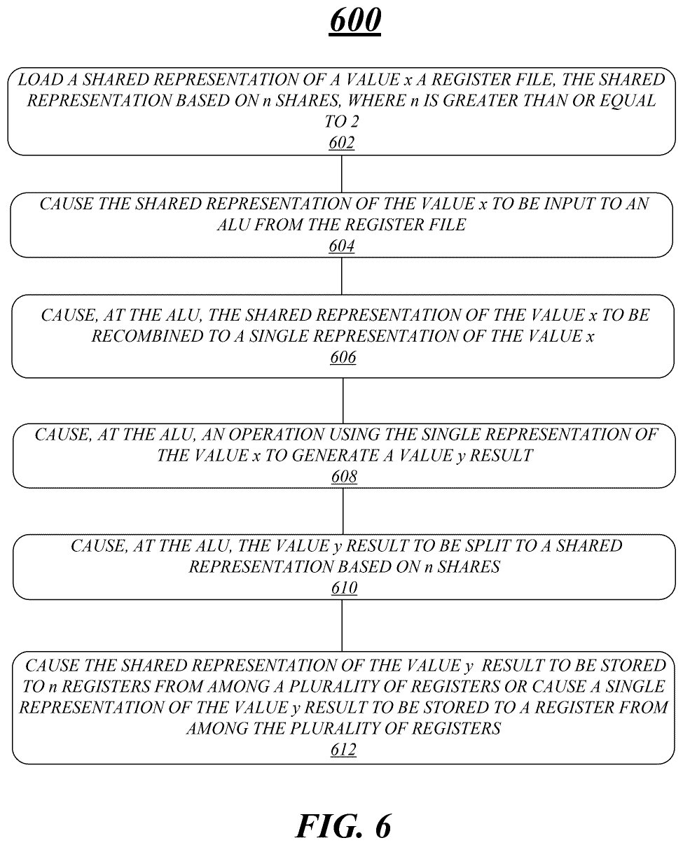

FIG. 6 illustrates an example logic flow 600. Logic flow 600 is representative of the operations implemented by circuitry, logic and/or features of countermeasure control circuitry included in a processing element. For example, circuitry, logic and/or features of countermeasure control circuitry 122 included in a core from among cores 0-N of computing system 100 as shown in FIGS. 1-2 and 4-5.

In some examples, as shown in FIG. 6, logic flow 600 at block 602 can load a shared representation of a value x to a register file, the shared representation based on n shares, where n is greater than or equal to 2. In an example where n=2 and the shared representation of a value x can include a first share x1 stored in a first register from among a plurality of registers and a second share x2 stored to in second register from among the plurality of registers, the shared representation of the value x is loaded directly from the first and second registers. In another example, the value x is stored in a single register from among a plurality of registers and logic of countermeasure control circuitry 122 such as LSU 220 can be configured to convert the value x to a shared representation of the value x prior to loading the shared representation of the value x to the register file. For either of these examples, the plurality of registers can be maintained in memory 210.

According to some examples, logic flow 600 at block 604 can cause the shared representation of the value x to be input to an ALU from the register file. For example, if n=2, LSU 220 can input x1 and x2 from respective R₁ and R′₁ of register file 230 in order to input the shared representation of the value x to ALU 240.

In some examples, logic flow 600 at block 606 can cause, at the ALU, the shared representation of the value x to be recombined to a single representation of the value x. For example, combination circuitry 242 at ALU 240 can cause x1 and x2 to be recombined to a single representation of the value x. If x1 and x2 are Boolean shares, then the recombination can be via a 2 operand XOR result (x=x1\hat{ }x2). If x1 and x2 are arithmetic shares, then the recombination can be via a 2 operand addition result (x=x1+x2).

In some examples, logic flow 600 at block 608 can cause, at the ALU, an operation using the single representation of the value x to generate a value y result. For example, operation circuitry 244 can use the single representation of the value x to generate the value y result. The operation can be a cryptographic operation where the single representation of the value x is a secret key and the value y result can be a cryptographic signature.

According to some examples, logic flow 600 at block 610 can cause, at the ALU, the value y result to be split to a shared representation based on n shares. For example, the value y result can be split to a shared representation of y1 and y2 such that if Boolean shares y=y1\hat{ }y2 or if arithmetic shares y=y1+y2.

In some examples, logic flow 600 at block 612 can cause the shared representation of the value y result to be stored to n registers from among a plurality of registers or cause a single representation the value y result to be stored to a register from among the plurality of registers. For example, y1 and y2 can be stored to first and second registers from among the plurality of registers maintained in memory 210 by LSU 210. In another example, y1 and y2 can be combined to a single representation of the value y result and stored to a single register maintained in memory 210.

The logic flow shown in FIG. 6 can be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a software or logic flow can be implemented by computer executable instructions stored on at least one non-transitory computer readable medium or machine readable medium, such as an optical, magnetic or semiconductor storage. The embodiments are not limited in this context.

Some examples are implemented in one or more computer architectures, cores, accelerators, graphics processing units, FPGAs, etc. Some examples are generated or are IP cores. Some examples utilize emulation and/or translation.

At least some examples of the disclosed technologies can be described in view of the following examples.

### Example Systems

Example 1. An example processing element can include a plurality of registers, at least one register of the plurality of registers configured to store a value x. The processing element can also include an arithmetic logic unit, and circuitry configured to load a shared representation of the value x to a register file, wherein the shared representation is based on n shares, where n is greater than or equal to 2. The circuitry can also be configured to cause the shared representation of the value x to be input to the ALU from the register file. The circuitry can also be configured to cause, at the ALU, the shared representation of the value x to be recombined to a single representation of the value x. The circuitry can also be configured to cause, at the ALU, an operation using the single representation of the value x to generate a value y result. The circuitry can also be configured to cause, at the ALU, the value y result to be split to a shared representation based on n shares. The circuitry can also be configured to cause the shared representation of the value y result to be stored to n registers from among the plurality of registers or cause a single representation of the value y result to be stored to a register from among the plurality of registers.

Example 2. The processing element of example 1, the operation using the single representation of the value x to generate a value y result can include a cryptographic operation. The value x can be a secret key and the value y result can be a cryptographic signature.

Example 3. The processing element of example 1, the shared representation of the value x can be n Boolean shares. The shared representation of the value x to be recombined to the single representation of the value x can be via an n operand XOR result generated based on the n Boolean shares.

Example 4. The processing element of example 1, the shared representation of the value x can be n arithmetic shares. the shared representation of the value x to be recombined to the single representation of the value x can be via an n operand addition result generated based on the n arithmetic shares.

Example 5. The processing element of example 1, the shared representation of the value x can be loaded from n registers from among the plurality of registers.

Example 6. The processing element of example 1, the circuitry can be further configured to convert the value x to the shared representation of the value x prior to loading the shared representation of the value x to the register file.

Example 7. The processing element of example 1, the single representation of the value x can have an m-bit integer value of z that can be casted to a floating point representation f, where m is any whole, positive number. The circuitry can be further configured to obtain a random number r to be generated such that z+r is greater than 0 and determine the floating point representation f based on float(z+r)−f−float(r).

Example 8. The processing element of example 1, the processing element can be a core of a multi-core processor, a core of a multi-core graphics processing unit, an accelerator, or a field programmable gate array.

Example 9. An example method implemented at a processing element can include loading a shared representation of a value x to a register file. The shared representation can be based on n shares, where n is greater than or equal to 2. The method can also include causing the shared representation of the value x to be input to an ALU from the register file. The method can also include causing, at the ALU, the shared representation of the value x to be recombined to a single representation of the value x. The method can also include causing, at the ALU, an operation using the single representation of the value x to generate a value y result. The method can also include causing, at the ALU, the value y result to be split to a shared representation based on n shares. The method can also include causing the shared representation of the value y result to be stored to n registers from among a plurality of registers or cause a single representation of the value y result to be stored to a register from among the plurality of registers.

Example 10. The method of example 9, the operation using the single representation of the value x to generate a value y result can be a cryptographic operation, and the value x can be a secret key and the value y result can be a cryptographic signature.

Example 11. The method of example 9, the shared representation of the value x can be n Boolean shares. The shared representation of the value x to be recombined to the single representation of the value x can be via an n operand XOR result generated based on the n Boolean shares.

Example 12. The method of example 9, the shared representation of the value x can be n arithmetic shares. The shared representation of the value x to be recombined to the single representation of the value x can be via an n operand addition result generated based on the n arithmetic shares.

Example 13. The method of example 9, the shared representation of the value x can be loaded from n registers from among the plurality of registers.

Example 14. The method of example 9 can also include converting the value x to the shared representation of the value x prior to loading the shared representation of the value x to the register file.

Example 15. The method of example 9, the single representation of the value x can have an m-bit integer value of z that is to be casted to a floating point representation f, where m is any whole, positive number. The method can further obtaining a random number r to be generated such that z+r is greater than 0 and determining the floating point representation f based on float (z+r)−f−float(r).

Example 16. An example at least one machine readable medium can include a plurality of instructions that in response to being executed by a system can cause the system to carry out a method according to any one of examples 9 to 15.

Example 17. An example apparatus can include means for performing the method of any one of examples 9 to 15.

Example 18. An example at least one machine readable medium can include a plurality of instructions that in response to being executed by a processing element can cause the processing element to load a shared representation of a value x to a register file. The shared representation can be based on n shares, where n is greater than or equal to 2. The instructions can also cause the processing element to cause the shared representation of the value x to be input to an ALU from the register file. The instructions can also cause the processing element to cause, at the ALU, an operation using the shared representation of the value x to generate a shared representation of a value y result. The instructions can also cause the processing element to cause the shared representation of the value y result to be stored to n registers from among a plurality of registers or cause single representation of the value y result to be stored to a register from among the plurality of registers.

Example 19. The at least one machine readable medium of example 18, the operation using the shared representation of the value x to generate the shared representation of the value y result can include a cryptographic operation. The value x can be a secret key and the shared representation of the value y result can be a cryptographic signature.

Example 20. The at least one machine readable medium of example 18, the shared representation of the value x can be n Boolean shares.

Example 21. The at least one machine readable medium of example 18, the shared representation of the value x can be n arithmetic shares.

Example 22. The at least one machine readable medium of example 18, the shared representation of the value x can be loaded from n registers from among the plurality of registers.

Example 23. The at least one machine readable medium of example 18, the instructions can further cause the processing element to convert the value x to the shared representation of the value x prior to loading the shared representation of the value x to the register file.

Example 24. The at least one machine readable medium of example 18, the shared representation of the value x can have separate m-bit integer values of z that can be casted to separate floating point representations f, where m is any whole, positive number. The instructions can further cause the processing element to obtain a random number r to be generated such that z+r is greater than 0 and determine the separate floating point representations f based on float(z+r)−f−float(r).

Example 25. An example system can include a plurality of processing elements, at least one of the processing elements can include a plurality of registers. At least one register of the plurality of registers can be configured to store a value x. At least one of the processing elements can also include an ALU and circuitry. The circuitry can be configured to load a shared representation of the value x to a register file. The shared representation can be based on n shares, where n is greater than or equal to 2. The circuitry can also be configured to cause the shared representation of the value x to be input to the ALU from the register file. The circuitry can also be configured to cause, at the ALU, the shared representation of the value x to be recombined to a single representation of the value x. The circuitry can also be configured to cause, at the ALU, an operation using the single representation of the value x to generate a value y result. The circuitry can also be configured to cause, at the ALU, the value y result to be split to a shared representation based on n shares. The circuitry can also be configured to cause the shared representation of the value y result to be stored to n registers from among the plurality of registers or cause a single representation of the value y result to be stored to a register from among the plurality of registers.

Example 26. The system of example 25, the operation using the single representation of the value x to generate a value y result can be a cryptographic operation. The value x can be a secret key and the value y result can be a cryptographic signature.

Example 27. The system of example 25, the shared representation of the value x can be n Boolean shares. The shared representation of the value x to be recombined to the single representation of the value x can be via an n operand XOR result generated based on the n Boolean shares.

Example 28. The system of example 25, the shared representation of the value x can be n arithmetic shares. The shared representation of the value x to be recombined to the single representation of the value x can be via an n operand addition result generated based on the n arithmetic shares.

Example 29. The system of example 25, the shared representation of the value x can be loaded from n registers from among the plurality of registers.

Example 30. The system of example 25, the circuitry can be further configured to convert the value x to the shared representation of the value x prior to loading the shared representation of the value x to the register file.

Example 31. The system of example 25, the single representation of the value x can have an m-bit integer value of z that can be casted to a floating point representation f, where m is any whole, positive number. The circuitry can be further configured to obtain a random number r to be generated such that z+r is greater than 0 and determine the floating point representation f based on float(z+r)−f−float(r).

Example 32. The system of example 25, the plurality processing elements can be included in a multi-core processor, a multi-core graphics processing unit, an accelerator, or a field programmable gate array.

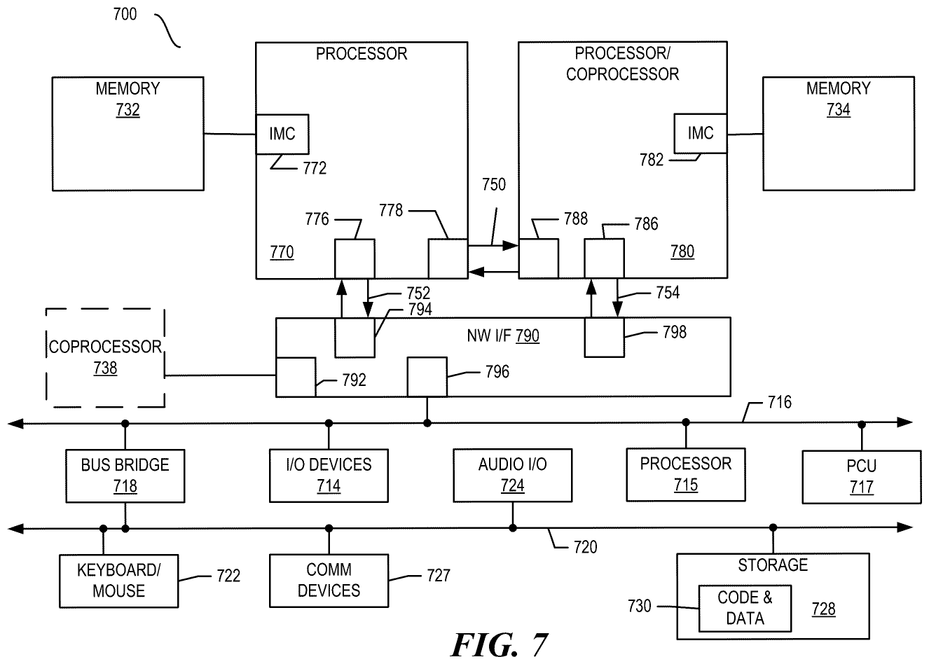

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement storage in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture. Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

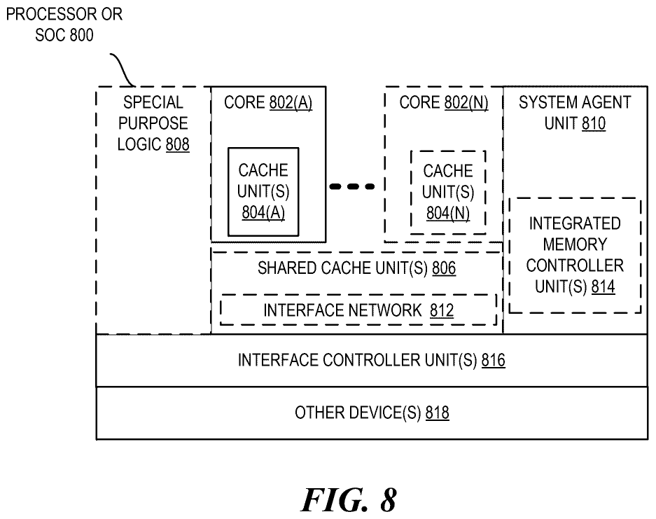

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

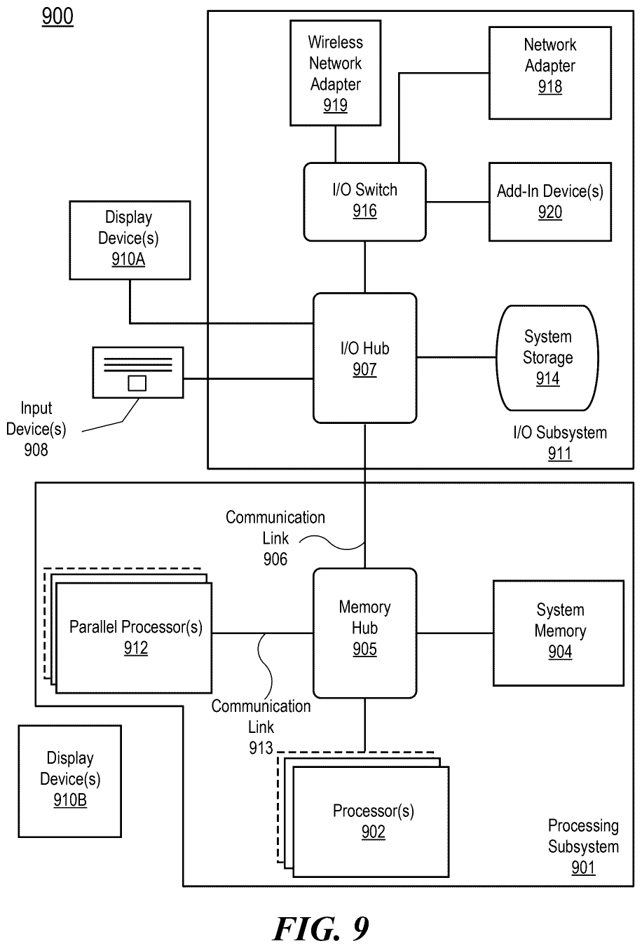

FIG. 9 is a block diagram illustrating a computing system 900 configured to implement one or more aspects of the examples described herein. The computing system 900 includes a processing subsystem 901 having one or more processor(s) 902 and a system memory 904 communicating via an interconnection path that may include a memory hub 905. The memory hub 905 may be a separate component within a chipset component or may be integrated within the one or more processor(s) 902. The memory hub 905 couples with an I/O subsystem 911 via a communication link 906. The I/O subsystem 911 includes an I/O hub 907 that can enable the computing system 900 to receive input from one or more input device(s) 908. Additionally, the I/O hub 907 can enable a display controller, which may be included in the one or more processor(s) 902, to provide outputs to one or more display device(s) 910A. In some examples the one or more display device(s) 910A coupled with the I/O hub 907 can include a local, internal, or embedded display device.

The processing subsystem 901, for example, includes one or more parallel processor(s) 912 coupled to memory hub 905 via a bus or other communication link 913. The communication link 913 may be one of any number of standards-based communication link technologies or protocols, such as, but not limited to PCI Express, or may be a vendor specific communications interface or communications fabric. The one or more parallel processor(s) 912 may form a computationally focused parallel or vector processing system that can include a large number of processing cores and/or processing clusters, such as a many integrated core (MIC) processor. For example, the one or more parallel processor(s) 912 form a graphics processing subsystem that can output pixels to one of the one or more display device(s) 910A coupled via the I/O hub 907. The one or more parallel processor(s) 912 can also include a display controller and display interface (not shown) to enable a direct connection to one or more display device(s) 910B.

Within the I/O subsystem 911, a system storage unit 914 can connect to the I/O hub 907 to provide a storage mechanism for the computing system 900. An I/O switch 916 can be used to provide an interface mechanism to enable connections between the I/O hub 907 and other components, such as a network adapter 918 and/or wireless network adapter 919 that may be integrated into the platform, and various other devices that can be added via one or more add-in device(s) 920. The add-in device(s) 920 may also include, for example, one or more external graphics processor devices, graphics cards, and/or compute accelerators. The network adapter 918 can be an Ethernet adapter or another wired network adapter. The wireless network adapter 919 can include one or more of a Wi-Fi, Bluetooth, near field communication (NFC), or other network device that includes one or more wireless radios.

The computing system 900 can include other components not explicitly shown, including USB or other port connections, optical storage drives, video capture devices, and the like, which may also be connected to the I/O hub 907. Communication paths interconnecting the various components in FIG. 9 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 912 may incorporate circuitry optimized for graphics and video processing, including, for example, video output circuitry, and constitutes a graphics processing unit (GPU). Alternatively or additionally, the one or more parallel processor(s) 912 can incorporate circuitry optimized for general purpose processing, while preserving the underlying computational architecture, described in greater detail herein. Components of the computing system 900 may be integrated with one or more other system elements on a single integrated circuit. For example, the one or more parallel processor(s) 912, memory hub 905, processor(s) 902, and I/O hub 907 can be integrated into a system on chip (SoC) integrated circuit. Alternatively, the components of the computing system 900 can be integrated into a single package to form a system in package (SIP) configuration. In some examples at least a portion of the components of the computing system 900 can be integrated into a multi-chip module (MCM), which can be interconnected with other multi-chip modules into a modular computing system.

It will be appreciated that the computing system 900 shown herein is illustrative and that variations and modifications are possible. The connection topology, including the number and arrangement of bridges, the number of processor(s) 902, and the number of parallel processor(s) 912, may be modified as desired. For instance, system memory 904 can be connected to the processor(s) 902 directly rather than through a bridge, while other devices communicate with system memory 904 via the memory hub 905 and the processor(s) 902. In other alternative topologies, the parallel processor(s) 912 are connected to the I/O hub 907 or directly to one of the one or more processor(s) 902, rather than to the memory hub 905. In other examples, the I/O hub 907 and memory hub 905 may be integrated into a single chip. It is also possible that two or more sets of processor(s) 902 are attached via multiple sockets, which can couple with two or more instances of the parallel processor(s) 912.

Some of the particular components shown herein are optional and may not be included in all implementations of the computing system 900. For example, any number of add-in cards or peripherals may be supported, or some components may be eliminated. Furthermore, some architectures may use different terminology for components similar to those illustrated in FIG. 9. For example, the memory hub 905 may be referred to as a Northbridge in some architectures, while the I/O hub 907 may be referred to as a Southbridge.

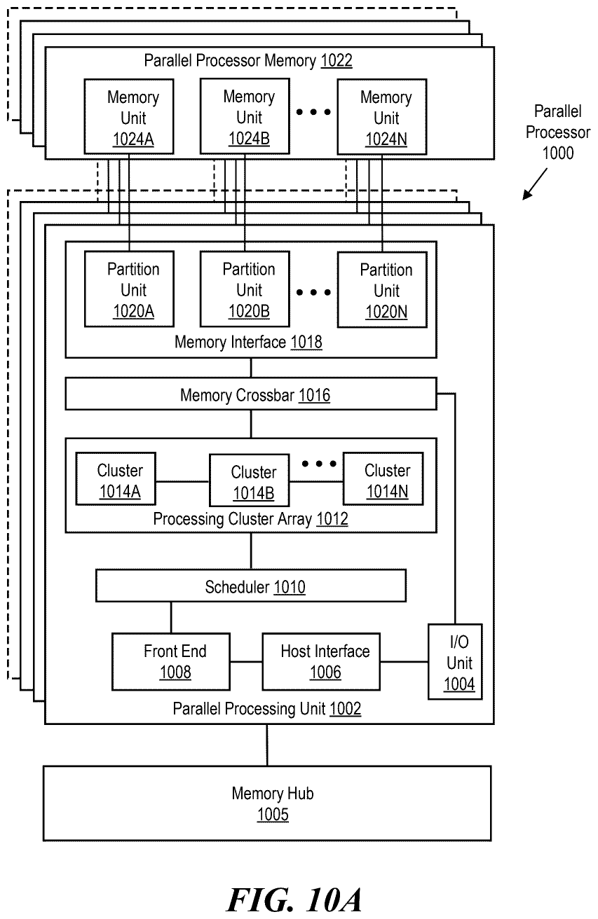

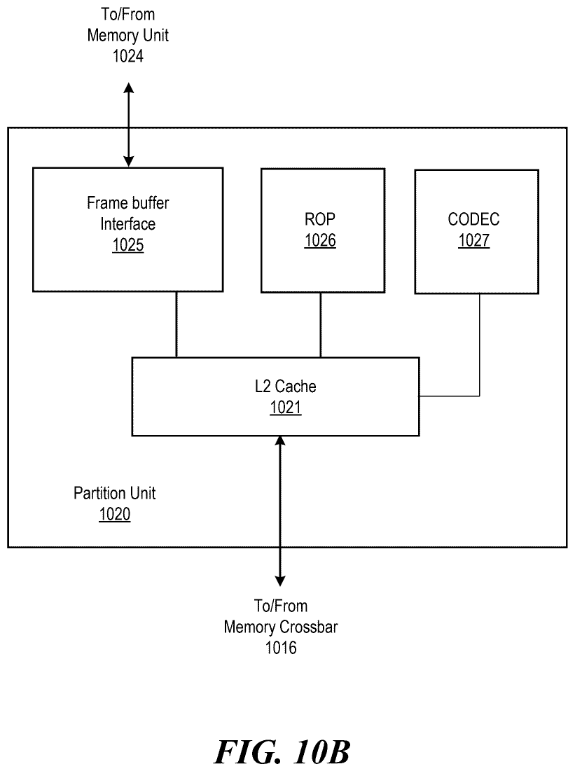

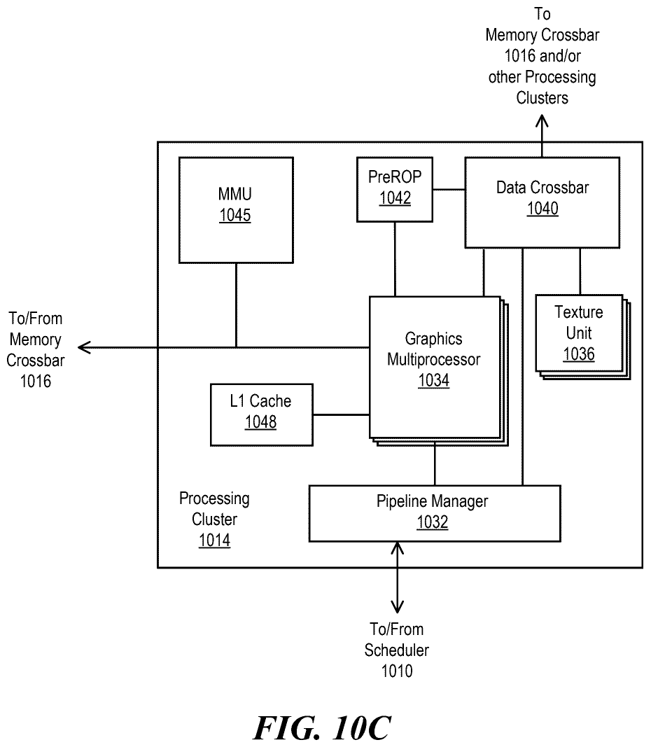

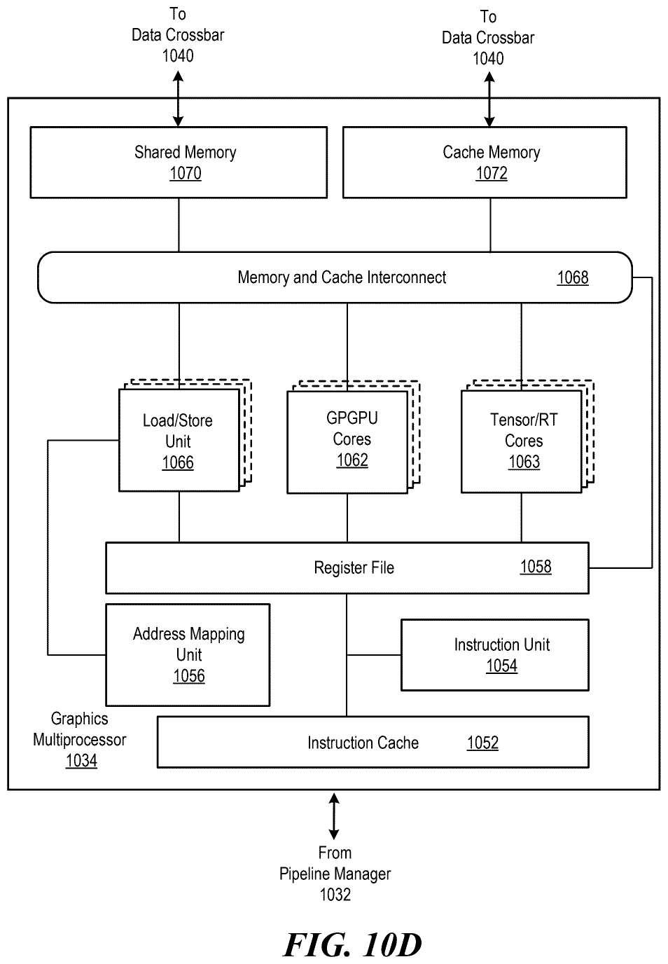

FIG. 10A illustrates examples of a parallel processor 1000. The parallel processor 1000 may be a GPU, GPGPU or the like as described herein. The various components of the parallel processor 1000 may be implemented using one or more integrated circuit devices, such as programmable processors, application specific integrated circuits (ASICs), or field programmable gate arrays (FPGA). The illustrated parallel processor 1000 may be one or more of the parallel processor(s) 912 shown in FIG. 9.

The parallel processor 1000 includes a parallel processing unit 1002. The parallel processing unit includes an I/O unit 1004 that enables communication with other devices, including other instances of the parallel processing unit 1002. The I/O unit 1004 may be directly connected to other devices. For instance, the I/O unit 1004 connects with other devices via the use of a hub or switch interface, such as memory hub 905. The connections between the memory hub 905 and the I/O unit 1004 form a communication link 913. Within the parallel processing unit 1002, the I/O unit 1004 connects with a host interface 1006 and a memory crossbar 1016, where the host interface 1006 receives commands directed to performing processing operations and the memory crossbar 1016 receives commands directed to performing memory operations.

When the host interface 1006 receives a command buffer via the I/O unit 1004, the host interface 1006 can direct work operations to perform those commands to a front end 1008. In some examples the front end 1008 couples with a scheduler 1010, which is configured to distribute commands or other work items to a processing cluster array 1012. The scheduler 1010 ensures that the processing cluster array 1012 is properly configured and in a valid state before tasks are distributed to the processing clusters of the processing cluster array 1012. The scheduler 1010 may be implemented via firmware logic executing on a microcontroller. The microcontroller implemented scheduler 1010 is configurable to perform complex scheduling and work distribution operations at coarse and fine granularity, enabling rapid preemption and context switching of threads executing on the processing cluster array 1012. Preferably, the host software can prove workloads for scheduling on the processing cluster array 1012 via one of multiple graphics processing doorbells. In other examples, polling for new workloads or interrupts can be used to identify or indicate availability of work to perform. The workloads can then be automatically distributed across the processing cluster array 1012 by the scheduler 1010 logic within the scheduler microcontroller.

The processing cluster array 1012 can include up to “N” processing clusters (e.g., cluster 1014A, cluster 1014B, through cluster 1014N). Each cluster 1014A-1014N of the processing cluster array 1012 can execute a large number of concurrent threads. The scheduler 1010 can allocate work to the clusters 1014A-1014N of the processing cluster array 1012 using various scheduling and/or work distribution algorithms, which may vary depending on the workload arising for each type of program or computation. The scheduling can be handled dynamically by the scheduler 1010 or can be assisted in part by compiler logic during compilation of program logic configured for execution by the processing cluster array 1012. Optionally, different clusters 1014A-1014N of the processing cluster array 1012 can be allocated for processing different types of programs or for performing different types of computations.

The processing cluster array 1012 can be configured to perform various types of parallel processing operations. For example, the processing cluster array 1012 is configured to perform general-purpose parallel compute operations. For example, the processing cluster array 1012 can include logic to execute processing tasks including filtering of video and/or audio data, performing modeling operations, including physics operations, and performing data transformations.

The processing cluster array 1012 is configured to perform parallel graphics processing operations. In such examples in which the parallel processor 1000 is configured to perform graphics processing operations, the processing cluster array 1012 can include additional logic to support the execution of such graphics processing operations, including, but not limited to texture sampling logic to perform texture operations, as well as tessellation logic and other vertex processing logic. Additionally, the processing cluster array 1012 can be configured to execute graphics processing related shader programs such as, but not limited to vertex shaders, tessellation shaders, geometry shaders, and pixel shaders. The parallel processing unit 1002 can transfer data from system memory via the I/O unit 1004 for processing. The transferred data can be stored to on-chip memory (e.g., parallel processor memory 1022) during processing, then written back to system memory.

In examples in which the parallel processing unit 1002 is used to perform graphics processing, the scheduler 1010 may be configured to divide the processing workload into approximately equal sized tasks, to better enable distribution of the graphics processing operations to multiple clusters 1014A-1014N of the processing cluster array 1012. In some of these examples, portions of the processing cluster array 1012 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 1014A-1014N may be stored in buffers to allow the intermediate data to be transmitted between clusters 1014A-1014N for further processing.

During operation, the processing cluster array 1012 can receive processing tasks to be executed via the scheduler 1010, which receives commands defining processing tasks from front end 1008. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 1010 may be configured to fetch the indices corresponding to the tasks or may receive the indices from the front end 1008. The front end 1008 can be configured to ensure the processing cluster array 1012 is configured to a valid state before the workload specified by incoming command buffers (e.g., batch-buffers, push buffers, etc.) is initiated.

Each of the one or more instances of the parallel processing unit 1002 can couple with parallel processor memory 1022. The parallel processor memory 1022 can be accessed via the memory crossbar 1016, which can receive memory requests from the processing cluster array 1012 as well as the I/O unit 1004. The memory crossbar 1016 can access the parallel processor memory 1022 via a memory interface 1018. The memory interface 1018 can include multiple partition units (e.g., partition unit 1020A, partition unit 1020B, through partition unit 1020N) that can each couple to a portion (e.g., memory unit) of parallel processor memory 1022. The number of partition units 1020A-1020N may be configured to be equal to the number of memory units, such that a first partition unit 1020A has a corresponding first memory unit 1024A, a second partition unit 1020B has a corresponding second memory unit 1024B, and an Nth partition unit 1020N has a corresponding Nth memory unit 1024N. In other examples, the number of partition units 1020A-1020N may not be equal to the number of memory devices.

The memory units 1024A-1024N can include various types of memory devices, including dynamic random-access memory (DRAM) or graphics random access memory, such as synchronous graphics random access memory (SGRAM), including graphics double data rate (GDDR) memory. Optionally, the memory units 1024A-1024N may also include 3D stacked memory, including but not limited to high bandwidth memory (HBM). Persons skilled in the art will appreciate that the specific implementation of the memory units 1024A-1024N can vary and can be selected from one of various conventional designs. Render targets, such as frame buffers or texture maps may be stored across the memory units 1024A-1024N, allowing partition units 1020A-1020N to write portions of each render target in parallel to efficiently use the available bandwidth of parallel processor memory 1022. In some examples, a local instance of the parallel processor memory 1022 may be excluded in favor of a unified memory design that utilizes system memory in conjunction with local cache memory.

Optionally, any one of the clusters 1014A-1014N of the processing cluster array 1012 has the ability to process data that will be written to any of the memory units 1024A-1024N within parallel processor memory 1022. The memory crossbar 1016 can be configured to transfer the output of each cluster 1014A-1014N to any partition unit 1020A-1020N or to another cluster 1014A-1014N, which can perform additional processing operations on the output. Each cluster 1014A-1014N can communicate with the memory interface 1018 through the memory crossbar 1016 to read from or write to various external memory devices. In one of the examples with the memory crossbar 1016 the memory crossbar 1016 has a connection to the memory interface 1018 to communicate with the I/O unit 1004, as well as a connection to a local instance of the parallel processor memory 1022, enabling the processing units within the different processing clusters 1014A-1014N to communicate with system memory or other memory that is not local to the parallel processing unit 1002. Generally, the memory crossbar 1016 may, for example, be able to use virtual channels to separate traffic streams between the clusters 1014A-1014N and the partition units 1020A-1020N.

While a single instance of the parallel processing unit 1002 is illustrated within the parallel processor 1000, any number of instances of the parallel processing unit 1002 can be included. For example, multiple instances of the parallel processing unit 1002 can be provided on a single add-in card, or multiple add-in cards can be interconnected. For example, the parallel processor 1000 can be an add-in device, such as add-in device 920 of FIG. 9, which may be a graphics card such as a discrete graphics card that includes one or more GPUs, one or more memory devices, and device-to-device or network or fabric interfaces. The different instances of the parallel processing unit 1002 can be configured to inter-operate even if the different instances have different numbers of processing cores, different amounts of local parallel processor memory, and/or other configuration differences. Optionally, some instances of the parallel processing unit 1002 can include higher precision floating point units relative to other instances. Systems incorporating one or more instances of the parallel processing unit 1002 or the parallel processor 1000 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 1002 can be partitioned into multiple instances. Those multiple instances can be configured to execute workloads associated with different clients in an isolated manner, enabling a pre-determined quality of service to be provided for each client. For example, each cluster 1014A-1014N can be compartmentalized and isolated from other clusters, allowing the processing cluster array 1012 to be divided into multiple compute partitions or instances. In such configuration, workloads that execute on an isolated partition are protected from faults or errors associated with a different workload that executes on a different partition. The partition units 1020A-1020N can be configured to enable a dedicated and/or isolated path to memory for the clusters 1014A-1014N associated with the respective compute partitions. This datapath isolation enables the compute resources within a partition can communicate with one or more assigned memory units 1024A-1024N without being subjected to inference by the activities of other partitions.

FIG. 10B is a block diagram of a partition unit 1020. The partition unit 1020 may be an instance of one of the partition units 1020A-1020N of FIG. 10A. As illustrated, the partition unit 1020 includes an L2 cache 1021, a frame buffer interface 1025, and a ROP 1026 (raster operations unit). The L2 cache 1021 is a read/write cache that is configured to perform load and store operations received from the memory crossbar 1016 and ROP 1026. Read misses and urgent writeback requests are output by L2 cache 1021 to frame buffer interface 1025 for processing. Updates can also be sent to the frame buffer via the frame buffer interface 1025 for processing. In some examples the frame buffer interface 1025 interfaces with one of the memory units in parallel processor memory, such as the memory units 1024A-1024N of FIG. 10A (e.g., within parallel processor memory 1022). The partition unit 1020 may additionally or alternatively also interface with one of the memory units in parallel processor memory via a memory controller (not shown).

In graphics applications, the ROP 1026 is a processing unit that performs raster operations such as stencil, z test, blending, and the like. The ROP 1026 then outputs processed graphics data that is stored in graphics memory. In some examples the ROP 1026 includes or couples with a CODEC 1027 that includes compression logic to compress depth or color data that is written to memory or the L2 cache 1021 and decompress depth or color data that is read from memory or the L2 cache 1021. The compression logic can be lossless compression logic that makes use of one or more of multiple compression algorithms. The type of compression that is performed by the CODEC 1027 can vary based on the statistical characteristics of the data to be compressed. For example, in some examples, delta color compression is performed on depth and color data on a per-tile basis. In some examples the CODEC 1027 includes compression and decompression logic that can compress and decompress compute data associated with machine learning operations. The CODEC 1027 can, for example, compress sparse matrix data for sparse machine learning operations. The CODEC 1027 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 1026 may be included within each processing cluster (e.g., cluster 1014A-1014N of FIG. 10A) instead of within the partition unit 1020. In such example, read and write requests for pixel data are transmitted over the memory crossbar 1016 instead of pixel fragment data. The processed graphics data may be displayed on a display device, such as one of the one or more display device(s) 910A-910B of FIG. 9, routed for further processing by the processor(s) 902, or routed for further processing by one of the processing entities within the parallel processor 1000 of FIG. 10A.

FIG. 10C is a block diagram of a processing cluster 1014 within a parallel processing unit. For example, the processing cluster is an instance of one of the processing clusters 1014A-1014N of FIG. 10A. The processing cluster 1014 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 1014 can be controlled via a pipeline manager 1032 that distributes processing tasks to SIMT parallel processors. The pipeline manager 1032 receives instructions from the scheduler 1010 of FIG. 10A and manages execution of those instructions via a graphics multiprocessor 1034 and/or a texture unit 1036. The illustrated graphics multiprocessor 1034 is an exemplary instance of a SIMT parallel processor. However, various types of SIMT parallel processors of differing architectures may be included within the processing cluster 1014. One or more instances of the graphics multiprocessor 1034 can be included within a processing cluster 1014. The graphics multiprocessor 1034 can process data and a data crossbar 1040 can be used to distribute the processed data to one of multiple possible destinations, including other shader units. The pipeline manager 1032 can facilitate the distribution of processed data by specifying destinations for processed data to be distributed via the data crossbar 1040.

Each graphics multiprocessor 1034 within the processing cluster 1014 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 1014 constitute a thread. A set of threads executing across the set of parallel processing engines is a thread group. A thread group executes the same program on different input data. Each thread within a thread group can be assigned to a different processing engine within a graphics multiprocessor 1034. A thread group may include fewer threads than the number of processing engines within the graphics multiprocessor 1034. When a thread group includes fewer threads than the number of processing engines, one or more of the processing engines may be idle during cycles in which that thread group is being processed. A thread group may also include more threads than the number of processing engines within the graphics multiprocessor 1034. When the thread group includes more threads than the number of processing engines within the graphics multiprocessor 1034, processing can be performed over consecutive clock cycles. Optionally, multiple thread groups can be executed concurrently on the graphics multiprocessor 1034.

The graphics multiprocessor 1034 may include an internal cache memory to perform load and store operations. Optionally, the graphics multiprocessor 1034 can forego an internal cache and use a cache memory (e.g., level 1 (L1) cache 1048) within the processing cluster 1014. Each graphics multiprocessor 1034 also has access to level 2 (L2) caches within the partition units (e.g., partition units 1020A-1020N of FIG. 10A) that are shared among all processing clusters 1014 and may be used to transfer data between threads. The graphics multiprocessor 1034 may also access off-chip global memory, which can include one or more of local parallel processor memory and/or system memory. Any memory external to the parallel processing unit 1002 may be used as global memory. Examples in which the processing cluster 1014 includes multiple instances of the graphics multiprocessor 1034 can share common instructions and data, which may be stored in the L1 cache 1048.

Each processing cluster 1014 may include an MMU 1045 (memory management unit) that is configured to map virtual addresses into physical addresses. In other examples, one or more instances of the MMU 1045 may reside within the memory interface 1018 of FIG. 10A. The MMU 1045 includes a set of page table entries (PTEs) used to map a virtual address to a physical address of a tile and optionally a cache line index. The MMU 1045 may include address translation lookaside buffers (TLB) or caches that may reside within the graphics multiprocessor 1034 or the L1 cache 1048 of processing cluster 1014. The physical address is processed to distribute surface data access locality to allow efficient request interleaving among partition units. The cache line index may be used to determine whether a request for a cache line is a hit or miss.

In graphics and computing applications, a processing cluster 1014 may be configured such that each graphics multiprocessor 1034 is coupled to a texture unit 1036 for performing texture mapping operations, e.g., determining texture sample positions, reading texture data, and filtering the texture data. Texture data is read from an internal texture L1 cache (not shown) or in some examples from the L1 cache within graphics multiprocessor 1034 and is fetched from an L2 cache, local parallel processor memory, or system memory, as needed. Each graphics multiprocessor 1034 outputs processed tasks to the data crossbar 1040 to provide the processed task to another processing cluster 1014 for further processing or to store the processed task in an L2 cache, local parallel processor memory, or system memory via the memory crossbar 1016. A preROP 1042 (pre-raster operations unit) is configured to receive data from graphics multiprocessor 1034, direct data to ROP units, which may be located with partition units as described herein (e.g., partition units 1020A-1020N of FIG. 10A). The preROP 1042 unit can perform optimizations for color blending, organize pixel color data, and perform address translations.

It will be appreciated that the core architecture described herein is illustrative and that variations and modifications are possible. Any number of processing units, e.g., graphics multiprocessor 1034, texture units 1036, preROPs 1042, etc., may be included within a processing cluster 1014. Further, while only one processing cluster 1014 is shown, a parallel processing unit as described herein may include any number of instances of the processing cluster 1014. Optionally, each processing cluster 1014 can be configured to operate independently of other processing clusters 1014 using separate and distinct processing units, L1 caches, L2 caches, etc.

FIG. 10D shows an example of the graphics multiprocessor 1034 in which the graphics multiprocessor 1034 couples with the pipeline manager 1032 of the processing cluster 1014. The graphics multiprocessor 1034 has an execution pipeline including but not limited to an instruction cache 1052, an instruction unit 1054, an address mapping unit 1056, a register file 1058, one or more general purpose graphics processing unit (GPGPU) cores 1062, and one or more load/store units 1066. The GPGPU cores 1062 and load/store units 1066 are coupled with cache memory 1072 and shared memory 1070 via a memory and cache interconnect 1068. The graphics multiprocessor 1034 may additionally include tensor and/or ray-tracing cores 1063 that include hardware logic to accelerate matrix and/or ray-tracing operations.

The instruction cache 1052 may receive a stream of instructions to execute from the pipeline manager 1032. The instructions are cached in the instruction cache 1052 and dispatched for execution by the instruction unit 1054. The instruction unit 1054 can dispatch instructions as thread groups (e.g., warps), with each thread of the thread group assigned to a different execution unit within GPGPU core 1062. An instruction can access any of a local, shared, or global address space by specifying an address within a unified address space. The address mapping unit 1056 can be used to translate addresses in the unified address space into a distinct memory address that can be accessed by the load/store units 1066.

The register file 1058 provides a set of registers for the functional units of the graphics multiprocessor 1034. The register file 1058 provides temporary storage for operands connected to the data paths of the functional units (e.g., GPGPU cores 1062, load/store units 1066) of the graphics multiprocessor 1034. The register file 1058 may be divided between each of the functional units such that each functional unit is allocated a dedicated portion of the register file 1058. For example, the register file 1058 may be divided between the different warps being executed by the graphics multiprocessor 1034.

The GPGPU cores 1062 can each include floating point units (FPUs) and/or integer arithmetic logic units (ALUs) that are used to execute instructions of the graphics multiprocessor 1034. In some implementations, the GPGPU cores 1062 can include hardware logic that may otherwise reside within the tensor and/or ray-tracing cores 1063. The GPGPU cores 1062 can be similar in architecture or can differ in architecture. For example and in some examples, a first portion of the GPGPU cores 1062 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 1034 can additionally include one or more fixed function or special function units to perform specific functions such as copy rectangle or pixel blending operations. One or more of the GPGPU cores can also include fixed or special function logic.

The GPGPU cores 1062 may include SIMD logic capable of performing a single instruction on multiple sets of data. Optionally, GPGPU cores 1062 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 1068 is an interconnect network that connects each of the functional units of the graphics multiprocessor 1034 to the register file 1058 and to the shared memory 1070. For example, the memory and cache interconnect 1068 is a crossbar interconnect that allows the load/store unit 1066 to implement load and store operations between the shared memory 1070 and the register file 1058. The register file 1058 can operate at the same frequency as the GPGPU cores 1062, thus data transfer between the GPGPU cores 1062 and the register file 1058 is very low latency. The shared memory 1070 can be used to enable communication between threads that execute on the functional units within the graphics multiprocessor 1034. The cache memory 1072 can be used as a data cache for example, to cache texture data communicated between the functional units and the texture unit 1036. The shared memory 1070 can also be used as a program managed cached. The shared memory 1070 and the cache memory 1072 can couple with the data crossbar 1040 to enable communication with other components of the processing cluster. Threads executing on the GPGPU cores 1062 can programmatically store data within the shared memory in addition to the automatically cached data that is stored within the cache memory 1072.

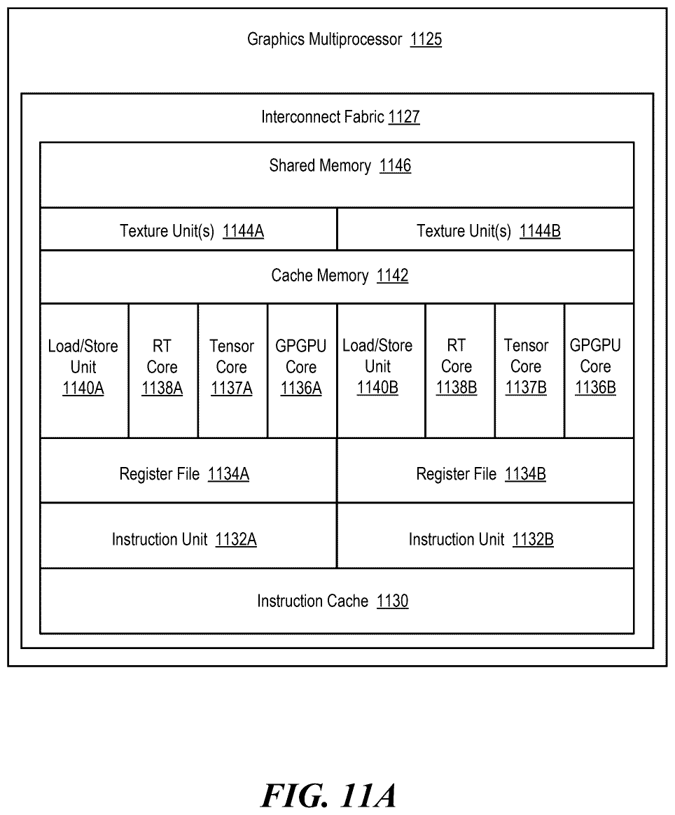

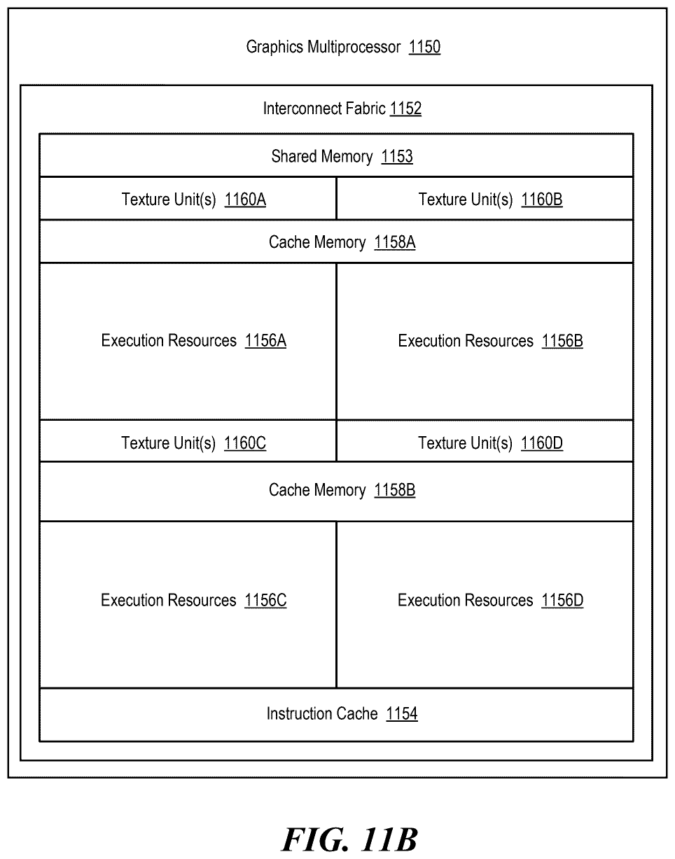

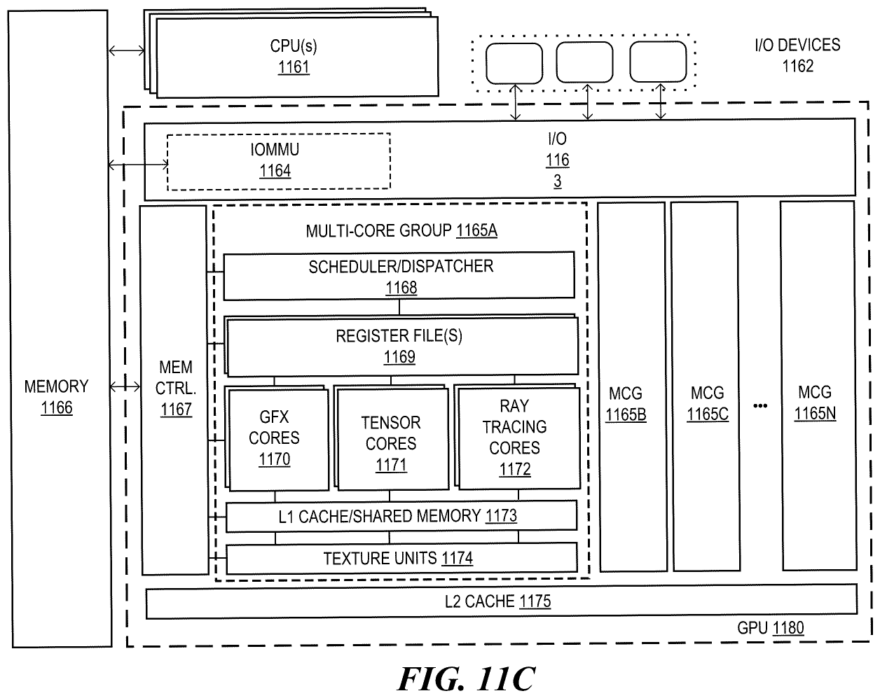

FIGS. 11A-11C illustrate additional graphics multiprocessors, according to examples. FIG. 11A-11B illustrate graphics multiprocessors 1125, 1150, which are related to the graphics multiprocessor 1034 of FIG. 10C and may be used in place of one of those. Therefore, the disclosure of any features in combination with the graphics multiprocessor 1034 herein also discloses a corresponding combination with the graphics multiprocessor(s) 1125, 1150, but is not limited to such. FIG. 11C illustrates a graphics processing unit (GPU) 1180 which includes dedicated sets of graphics processing resources arranged into multi-core groups 1165A-1165N, which correspond to the graphics multiprocessors 1125, 1150. The illustrated graphics multiprocessors 1125, 1150 and the multi-core groups 1165A-1165N can be streaming multiprocessors (SM) capable of simultaneous execution of a large number of execution threads.

The graphics multiprocessor 1125 of FIG. 11A includes multiple additional instances of execution resource units relative to the graphics multiprocessor 1034 of FIG. 10D. For example, the graphics multiprocessor 1125 can include multiple instances of the instruction unit 1132A-1132B, register file 1134A-1134B, and texture unit(s) 1144A-1144B. The graphics multiprocessor 1125 also includes multiple sets of graphics or compute execution units (e.g., GPGPU core 1136A-1136B, tensor core 1137A-1137B, ray-tracing core 1138A-1138B) and multiple sets of load/store units 1140A-1140B. The execution resource units have a common instruction cache 1130, texture and/or data cache memory 1142, and shared memory 1146.

The various components can communicate via an interconnect fabric 1127. The interconnect fabric 1127 may include one or more crossbar switches to enable communication between the various components of the graphics multiprocessor 1125. The interconnect fabric 1127 may be a separate, high-speed network fabric layer upon which each component of the graphics multiprocessor 1125 is stacked. The components of the graphics multiprocessor 1125 communicate with remote components via the interconnect fabric 1127. For example, the cores 1136A-1136B, 1137A-1137B, and 1138A-1138B can each communicate with shared memory 1146 via the interconnect fabric 1127. The interconnect fabric 1127 can arbitrate communication within the graphics multiprocessor 1125 to ensure a fair bandwidth allocation between components.

The graphics multiprocessor 1150 of FIG. 11B includes multiple sets of execution resources 1156A-1156D, where each set of execution resource includes multiple instruction units, register files, GPGPU cores, and load store units, as illustrated in FIG. 10D and FIG. 11A. The execution resources 1156A-1156D can work in concert with texture unit(s) 1160A-1160D for texture operations, while sharing an instruction cache 1154, and shared memory 1153. For example, the execution resources 1156A-1156D can share an instruction cache 1154 and shared memory 1153, as well as multiple instances of a texture and/or data cache memory 1158A-1158B. The various components can communicate via an interconnect fabric 1152 similar to the interconnect fabric 1127 of FIG. 11A.

Persons skilled in the art will understand that the architecture described in FIG. 1, 10A-10D, and 11A-11B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 1002 of FIG. 10A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 11C illustrates a graphics processing unit (GPU) 1180 which includes dedicated sets of graphics processing resources arranged into multi-core groups 1165A-1165N. While the details of only a single multi-core group 1165A are provided, it will be appreciated that the other multi-core groups 1165B-1165N may be equipped with the same or similar sets of graphics processing resources. Details described with respect to the multi-core groups 1165A-1165N may also apply to any graphics multiprocessor 1034, 1125, 1150 described herein.

As illustrated, a multi-core group 1165A may include a set of graphics cores 1170, a set of tensor cores 1171, and a set of ray tracing cores 1172. A scheduler/dispatcher 1168 schedules and dispatches the graphics threads for execution on the various cores 1170, 1171, 1172. A set of register files 1169 store operand values used by the cores 1170, 1171, 1172 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1173 store graphics data such as texture data, vertex data, pixel data, ray data, bounding volume data, etc., locally within each multi-core group 1165A. One or more texture units 1174 can also be used to perform texturing operations, such as texture mapping and sampling. A Level 2 (L2) cache 1175 shared by all or a subset of the multi-core groups 1165A-1165N stores graphics data and/or instructions for multiple concurrent graphics threads. As illustrated, the L2 cache 1175 may be shared across a plurality of multi-core groups 1165A-1165N. One or more memory controllers 1167 couple the GPU 1180 to a memory 1166 which may be a system memory (e.g., DRAM) and/or a dedicated graphics memory (e.g., GDDR6 memory).

Input/output (I/O) circuitry 1163 couples the GPU 1180 to one or more I/O devices 1162 such as digital signal processors (DSPs), network controllers, or user input devices. An on-chip interconnect may be used to couple the I/O devices 1162 to the GPU 1180 and memory 1166. One or more I/O memory management units (IOMMUs) 1164 of the I/O circuitry 1163 couple the I/O devices 1162 directly to the system memory 1166. Optionally, the IOMMU 1164 manages multiple sets of page tables to map virtual addresses to physical addresses in system memory 1166. The I/O devices 1162, CPU(s) 1161, and GPU(s) 1180 may then share the same virtual address space.

In one implementation of the IOMMU 1164, the IOMMU 1164 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1166). The base addresses of each of the first and second sets of page tables may be stored in control registers and swapped out on a context switch (e.g., so that the new context is provided with access to the relevant set of page tables). While not illustrated in FIG. 11C, each of the cores 1170, 1171, 1172 and/or multi-core groups 1165A-1165N may include translation lookaside buffers (TLBs) to cache guest virtual to guest physical translations, guest physical to host physical translations, and guest virtual to host physical translations.

The CPU(s) 1161, GPUs 1180, and I/O devices 1162 may be integrated on a single semiconductor chip and/or chip package. The illustrated memory 1166 may be integrated on the same chip or may be coupled to the memory controllers 1167 via an off-chip interface. In one implementation, the memory 1166 comprises GDDR6 memory which shares the same virtual address space as other physical system-level memories, although the underlying principles described herein are not limited to this specific implementation.

The tensor cores 1171 may include a plurality of execution units specifically designed to perform matrix operations, which are the fundamental compute operation used to perform deep learning operations. For example, simultaneous matrix multiplication operations may be used for neural network training and inferencing. The tensor cores 1171 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1171. The training of neural networks, in particular, requires a significant number of matrix dot product operations. In order to process an inner-product formulation of an N×N×N matrix multiply, the tensor cores 1171 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1171 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat 16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1171 support a sparse mode of operation for matrices in which the vast majority of values are zero. The tensor cores 1171 include support for sparse input matrices that are encoded in a sparse matrix representation (e.g., coordinate list encoding (COO), compressed sparse row (CSR), compress sparse column (CSC), etc.). The tensor cores 1171 also include support for compressed sparse matrix representations in the event that the sparse matrix representation may be further compressed. Compressed, encoded, and/or compressed and encoded matrix data, along with associated compression and/or encoding metadata, can be read by the tensor cores 1171 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1171, output matrix C may be output in a compressed format, a sparse encoding, or a compressed sparse encoding.

The ray tracing cores 1172 may accelerate ray tracing operations for both real-time ray tracing and non-real-time ray tracing implementations. In particular, the ray tracing cores 1172 may include ray traversal/intersection circuitry for performing ray traversal using bounding volume hierarchies (BVHs) and identifying intersections between rays and primitives enclosed within the BVH volumes. The ray tracing cores 1172 may also include circuitry for performing depth testing and culling (e.g., using a Z buffer or similar arrangement). In one implementation, the ray tracing cores 1172 perform traversal and intersection operations in concert with the image denoising techniques described herein, at least a portion of which may be executed on the tensor cores 1171. For example, the tensor cores 1171 may implement a deep learning neural network to perform denoising of frames generated by the ray tracing cores 1172. However, the CPU(s) 1161, graphics cores 1170, and/or ray tracing cores 1172 may also implement all or a portion of the denoising and/or deep learning algorithms.

In addition, as described above, a distributed approach to denoising may be employed in which the GPU 1180 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1172 may process all BVH traversal and/or ray-primitive intersections, saving the graphics cores 1170 from being overloaded with thousands of instructions per ray. For example, each ray tracing core 1172 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1165A can simply launch a ray probe, and the ray tracing cores 1172 independently perform ray traversal and intersection and return hit data (e.g., a hit, no hit, multiple hits, etc.) to the thread context. The other cores 1170, 1171 are freed to perform other graphics or compute work while the ray tracing cores 1172 perform the traversal and intersection operations.

Optionally, each ray tracing core 1172 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1170 and tensor cores 1171) are freed to perform other forms of graphics work.

In some examples described below, a hybrid rasterization/ray tracing approach is used in which work is distributed between the graphics cores 1170 and ray tracing cores 1172.

The ray tracing cores 1172 (and/or other cores 1170, 1171) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1172, graphics cores 1170 and tensor cores 1171 is Vulkan API (e.g., Vulkan version 1.1.85 and later). Note, however, that the underlying principles described herein are not limited to any particular ray tracing ISA.

In general, the various cores 1172, 1171, 1170 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1172 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1172 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1172 can also be used to perform computations that are not directly analogous to ray tracing. For example, mesh projection, mesh refinement, and volume sampling computations can be accelerated using the ray tracing cores 1172. Generic coordinate space calculations, such as nearest neighbor calculations can also be performed. For example, the set of points near a given point can be discovered by defining a bounding box in the coordinate space around the point. BVH and ray probe logic within the ray tracing cores 1172 can then be used to determine the set of point intersections within the bounding box. The intersections constitute the origin point and the nearest neighbors to that origin point. Computations that are performed using the ray tracing cores 1172 can be performed in parallel with computations performed on the graphics cores 1172 and tensor cores 1171. A shader compiler can be configured to compile a compute shader or other general-purpose graphics processing program into low level primitives that can be parallelized across the graphics cores 1170, tensor cores 1171, and ray tracing cores 1172.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Examples described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

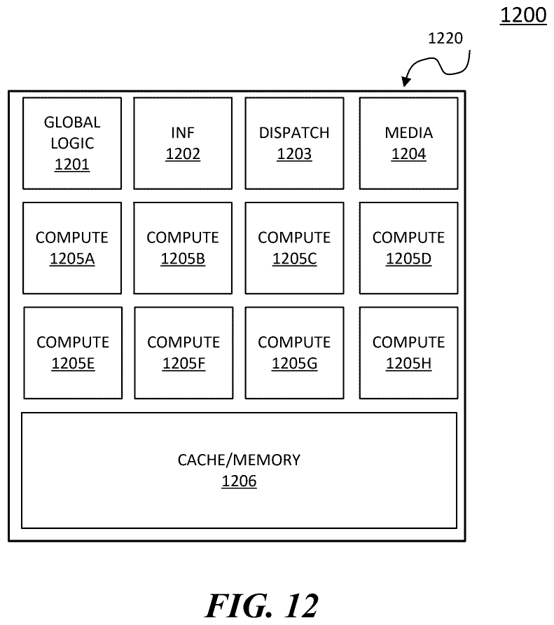

FIG. 12 shows a parallel compute system 1200, according to some examples. In some examples the parallel compute system 1200 includes a parallel processor 1220, which can be a graphics processor or compute accelerator as described herein. The parallel processor 1220 includes a global logic unit 1201, an interface 1202, a thread dispatcher 1203, a media unit 1204, a set of compute units 1205A-1205H, and a cache/memory units 1206. The global logic unit 1201, in some examples, includes global functionality for the parallel processor 1220, including device configuration registers, global schedulers, power management logic, and the like. The interface 1202 can include a front-end interface for the parallel processor 1220. The thread dispatcher 1203 can receive workloads from the interface 1202 and dispatch threads for the workload to the compute units 1205A-1205H. If the workload includes any media operations, at least a portion of those operations can be performed by the media unit 1204. The media unit can also offload some operations to the compute units 1205A-1205H. The cache/memory units 1206 can include cache memory (e.g., L3 cache) and local memory (e.g., HBM, GDDR) for the parallel processor 1220.

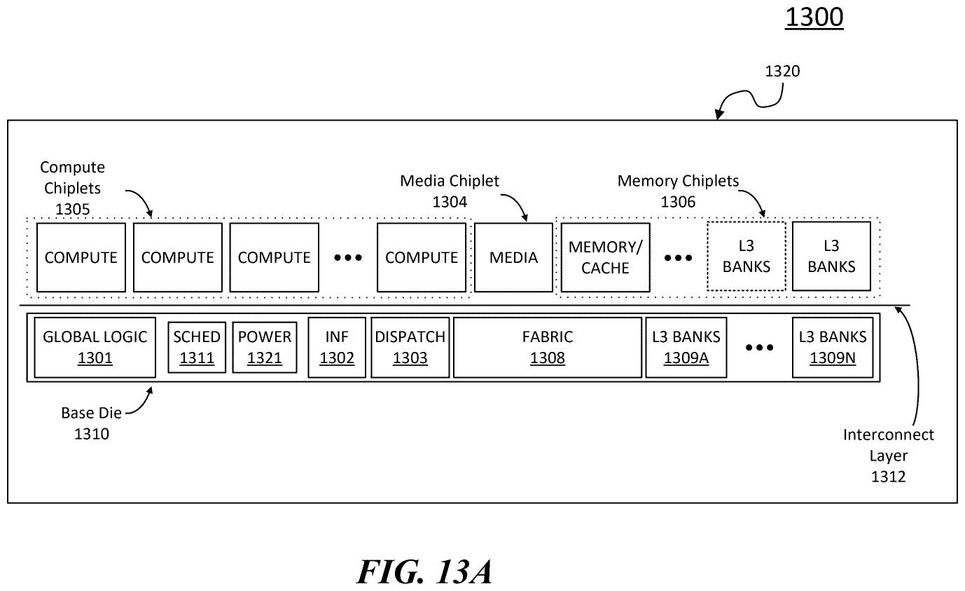

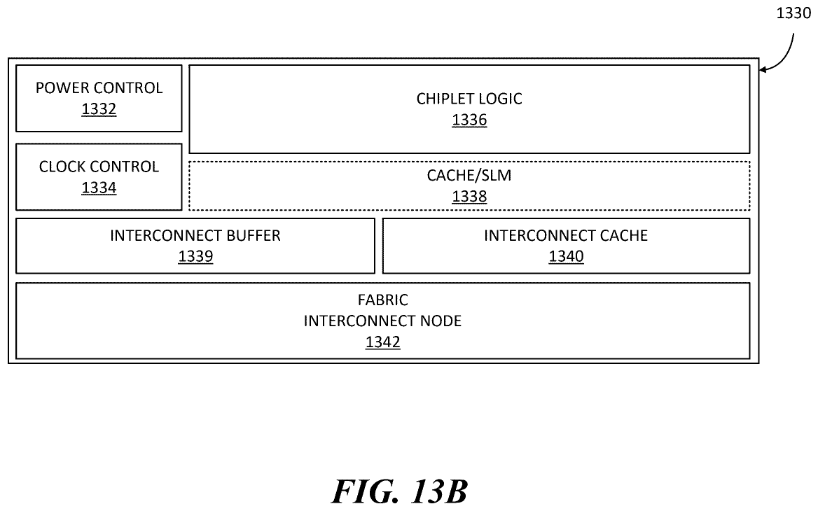

FIGS. 13A-13B illustrate a hybrid logical/physical view of a disaggregated parallel processor, according to examples described herein. FIG. 13A illustrates a disaggregated parallel compute system 1300. FIG. 13B illustrates a chiplet 1330 of the disaggregated parallel compute system 1300.

As shown in FIG. 13A, a disaggregated compute system 1300 can include a parallel processor 1320 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1305, a media chiplet 1304, and memory chiplets 1306. Each chiplet can be separately manufactured using different process technologies. For example, compute chiplets 1305 may be manufactured using the smallest or most advanced process technology available at the time of fabrication, while memory chiplets 1306 or other chiplets (e.g., I/O, networking, etc.) may be manufactured using a larger or less advanced process technologies.

The various chiplets can be bonded to a base die 1310 and configured to communicate with each other and logic within the base die 1310 via an interconnect layer 1312. In some examples, the base die 1310 can include global logic 1301, which can include scheduler 1311 and power management 1321 logic units, an interface 1302, a dispatch unit 1303, and an interconnect fabric module 1308 coupled with or integrated with one or more L3 cache banks 1309A-1309N. The interconnect fabric 1308 can be an inter-chiplet fabric that is integrated into the base die 1310. Logic chiplets can use the fabric 1308 to relay messages between the various chiplets. Additionally, L3 cache banks 1309A-1309N in the base die and/or L3 cache banks within the memory chiplets 1306 can cache data read from and transmitted to DRAM chiplets within the memory chiplets 1306 and to system memory of a host.

In some examples the global logic 1301 is a microcontroller that can execute firmware to perform scheduler 1311 and power management 1321 functionality for the parallel processor 1320. The microcontroller that executes the global logic can be tailored for the target use case of the parallel processor 1320. The scheduler 1311 can perform global scheduling operations for the parallel processor 1320. The power management 1321 functionality can be used to enable or disable individual chiplets within the parallel processor when those chiplets are not in use.

The various chiplets of the parallel processor 1320 can be designed to perform specific functionality that, in existing designs, would be integrated into a single die. A set of compute chiplets 1305 can include clusters of compute units (e.g., execution units, streaming multiprocessors, etc.) that include programmable logic to execute compute or graphics shader instructions. A media chiplet 1304 can include hardware logic to accelerate media encode and decode operations. Memory chiplets 1306 can include volatile memory (e.g., DRAM) and one or more SRAM cache memory banks (e.g., L3 banks).

As shown in FIG. 13B, each chiplet 1330 can include common components and application specific components. Chiplet logic 1336 within the chiplet 1330 can include the specific components of the chiplet, such as an array of streaming multiprocessors, compute units, or execution units described herein. The chiplet logic 1336 can couple with an optional cache or shared local memory 1338 or can include a cache or shared local memory within the chiplet logic 1336. The chiplet 1330 can include a fabric interconnect node 1342 that receives commands via the inter-chiplet fabric. Commands and data received via the fabric interconnect node 1342 can be stored temporarily within an interconnect buffer 1339. Data transmitted to and received from the fabric interconnect node 1342 can be stored in an interconnect cache 1340. Power control 1332 and clock control 1334 logic can also be included within the chiplet. The power control 1332 and clock control 1334 logic can receive configuration commands via the fabric can configure dynamic voltage and frequency scaling for the chiplet 1330. In some examples, each chiplet can have an independent clock domain and power domain and can be clock gated and power gated independently of other chiplets.

At least a portion of the components within the illustrated chiplet 1330 can also be included within logic embedded within the base die 1310 of FIG. 13A. For example, logic within the base die that communicates with the fabric can include a version of the fabric interconnect node 1342. Base die logic that can be independently clock or power gated can include a version of the power control 1332 and/or clock control 1334 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Example Core Architectures—In-order and out-of-order core block diagram.

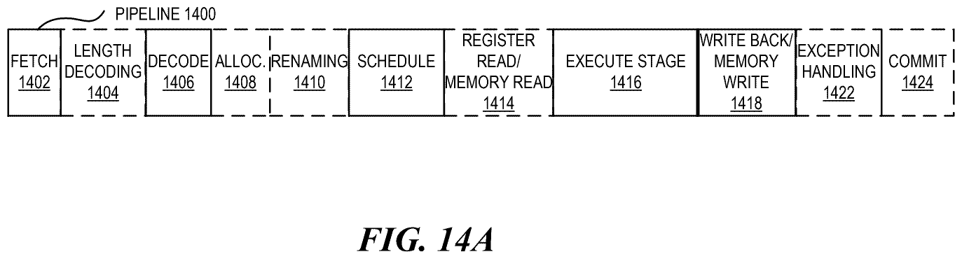

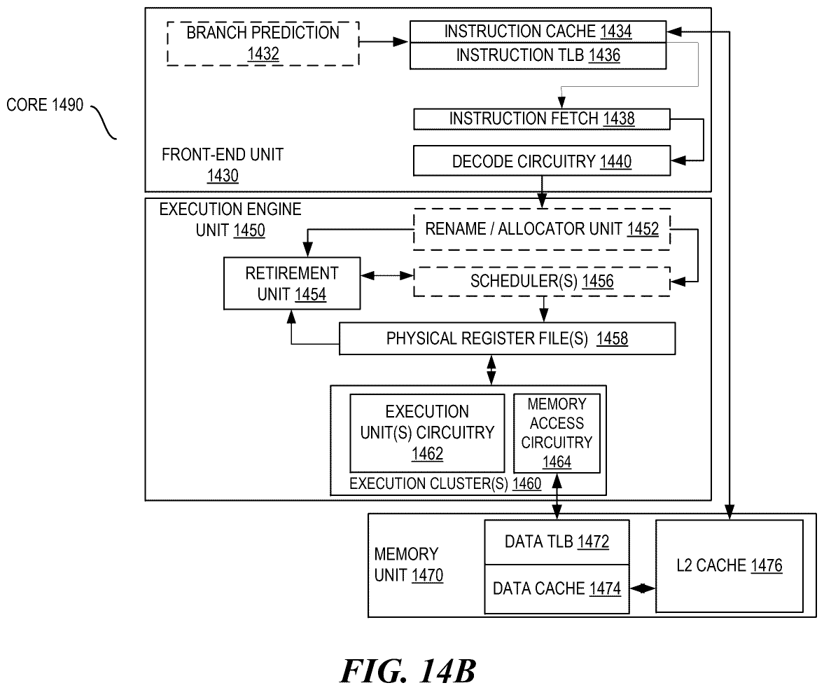

FIG. 14A is a block diagram illustrating both an example in-order pipeline and an example register renaming, out-of-order issue/execution pipeline according to examples. FIG. 14B is a block diagram illustrating both an example in-order architecture core and an example register renaming, out-of-order issue/execution architecture core to be included in a processor according to examples. The solid lined boxes in FIGS. 14A-14B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14A, a processor pipeline 1400 includes a fetch stage 1402, an optional length decoding stage 1404, a decode stage 1406, an optional allocation (Alloc) stage 1408, an optional renaming stage 1410, a schedule (also known as a dispatch or issue) stage 1412, an optional register read/memory read stage 1414, an execute stage 1416, a write back/memory write stage 1418, an optional exception handling stage 1422, and an optional commit stage 1424. One or more operations can be performed in each of these processor pipeline stages. For example, during the fetch stage 1402, one or more instructions are fetched from instruction memory, and during the decode stage 1406, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1406 and the register read/memory read stage 1414 may be combined into one pipeline stage. In some examples, during the execute stage 1416, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 14B may implement the pipeline 1400 as follows: 1) the instruction fetch circuitry 1438 performs the fetch and length decoding stages 1402 and 1404; 2) the decode circuitry 1440 performs the decode stage 1406; 3) the rename/allocator unit circuitry 1452 performs the allocation stage 1408 and renaming stage 1410; 4) the scheduler(s) circuitry 1456 performs the schedule stage 1412; 5) the physical register file(s) circuitry 1458 and the memory unit circuitry 1470 perform the register read/memory read stage 1414; the execution cluster(s) 1460 perform the execute stage 1416; 6) the memory unit circuitry 1470 and the physical register file(s) circuitry 1458 perform the write back/memory write stage 1418; 7) various circuitry may be involved in the exception handling stage 1422; and 8) the retirement unit circuitry 1454 and the physical register file(s) circuitry 1458 perform the commit stage 1424.

FIG. 14B shows a processor core 1490 including front-end unit circuitry 1430 coupled to execution engine unit circuitry 1450, and both are coupled to memory unit circuitry 1470. The core 1490 may be a reduced instruction set architecture computing (RISC) core, a complex instruction set architecture computing (CISC) core, a very long instruction word (VLIW) core, or a hybrid or alternative core type. As yet another option, the core 1490 may be a special-purpose core, such as, for example, a network or communication core, compression engine, coprocessor core, general purpose computing graphics processing unit (GPGPU) core, graphics core, or the like.

The front-end unit circuitry 1430 may include branch prediction circuitry 1432 coupled to instruction cache circuitry 1434, which is coupled to an instruction translation lookaside buffer (TLB) 1436, which is coupled to instruction fetch circuitry 1438, which is coupled to decode circuitry 1440. In some examples, the instruction cache circuitry 1434 is included in the memory unit circuitry 1470 rather than the front-end circuitry 1430. The decode circuitry 1440 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1440 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1440 may be implemented using various different mechanisms. Examples of suitable mechanisms include, but are not limited to, look-up tables, hardware implementations, programmable logic arrays (PLAs), microcode read only memories (ROMs), etc. In some examples, the core 1490 includes a microcode ROM (not shown) or other medium that stores microcode for certain macroinstructions (e.g., in decode circuitry 1440 or otherwise within the front-end circuitry 1430). In some examples, the decode circuitry 1440 includes a micro-operation (micro-op) or operation cache (not shown) to hold/cache decoded operations, micro-tags, or micro-operations generated during the decode or other stages of the processor pipeline 1400. The decode circuitry 1440 may be coupled to rename/allocator unit circuitry 1452 in the execution engine circuitry 1450.

The execution engine circuitry 1450 includes the rename/allocator unit circuitry 1452 coupled to retirement unit circuitry 1454 and a set of one or more scheduler(s) circuitry 1456. The scheduler(s) circuitry 1456 represents any number of different schedulers, including reservations stations, central instruction window, etc. In some examples, the scheduler(s) circuitry 1456 can include arithmetic logic unit (ALU) scheduler/scheduling circuitry, ALU queues, address generation unit (AGU) scheduler/scheduling circuitry, AGU queues, etc. The scheduler(s) circuitry 1456 is coupled to the physical register file(s) circuitry 1458. Each of the physical register file(s) circuitry 1458 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1458 includes vector registers unit circuitry, writemask registers unit circuitry, and scalar register unit circuitry. These register units may provide architectural vector registers, vector mask registers, general-purpose registers, etc. The physical register file(s) circuitry 1458 is coupled to the retirement unit circuitry 1454 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1454 and the physical register file(s) circuitry 1458 are coupled to the execution cluster(s) 1460. The execution cluster(s) 1460 includes a set of one or more execution unit(s) circuitry 1462 and a set of one or more memory access circuitry 1464. The execution unit(s) circuitry 1462 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1456, physical register file(s) circuitry 1458, and execution cluster(s) 1460 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1464). It should also be understood that where separate pipelines are used, one or more of these pipelines may be out-of-order issue/execution and the rest in-order.

In some examples, the execution engine unit circuitry 1450 may perform load store unit (LSU) address/data pipelining to an Advanced Microcontroller Bus (AMB) interface (not shown), and address phase and writeback, data phase load, store, and branches.

The set of memory access circuitry 1464 is coupled to the memory unit circuitry 1470, which includes data TLB circuitry 1472 coupled to data cache circuitry 1474 coupled to level 2 (L2) cache circuitry 1476. In some examples, the memory access circuitry 1464 may include load unit circuitry, store address unit circuitry, and store data unit circuitry, each of which is coupled to the data TLB circuitry 1472 in the memory unit circuitry 1470. The instruction cache circuitry 1434 is further coupled to the level 2 (L2) cache circuitry 1476 in the memory unit circuitry 1470. In some examples, the instruction cache 1434 and the data cache 1474 are combined into a single instruction and data cache (not shown) in L2 cache circuitry 1476, level 3 (L3) cache circuitry (not shown), and/or main memory. The L2 cache circuitry 1476 is coupled to one or more other levels of cache and eventually to a main memory.

The core 1490 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 1490 includes logic to support a packed data instruction set architecture extension (e.g., AVX1, AVX2), thereby allowing the operations used by many multimedia applications to be performed using packed data.

### Example Execution Unit(s) Circuitry.

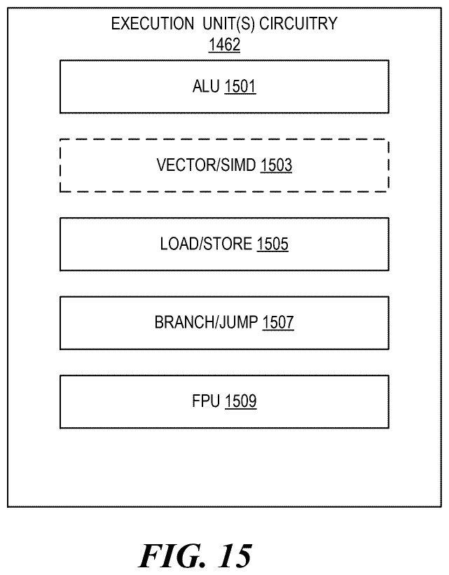

FIG. 15 illustrates examples of execution unit(s) circuitry, such as execution unit(s) circuitry 1462 of FIG. 14B. As illustrated, execution unit(s) circuitry 1462 may include one or more ALU circuits 1501, optional vector/single instruction multiple data (SIMD) circuits 1503, load/store circuits 1505, branch/jump circuits 1507, and/or Floating-point unit (FPU) circuits 1509. ALU circuits 1501 perform integer arithmetic and/or Boolean operations. Vector/SIMD circuits 1503 perform vector/SIMD operations on packed data (such as SIMD/vector registers). Load/store circuits 1505 execute load and store instructions to load data from memory into registers or store from registers to memory. Load/store circuits 1505 may also generate addresses. Branch/jump circuits 1507 cause a branch or jump to a memory address depending on the instruction. FPU circuits 1509 perform floating-point arithmetic. The width of the execution unit(s) circuitry 1462 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

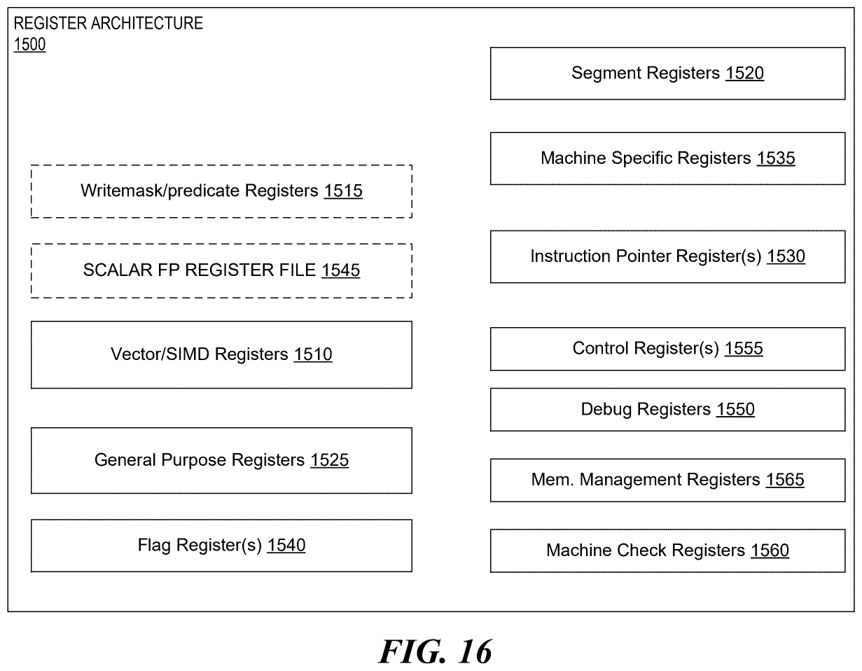

FIG. 16 is a block diagram of a register architecture 1600 according to some examples. As illustrated, the register architecture 1600 includes vector/SIMD registers 1610 that vary from 128-bit to 1,024 bits width. In some examples, the vector/SIMD registers 1610 are physically 512-bits and, depending upon the mapping, only some of the lower bits are used. For example, in some examples, the vector/SIMD registers 1610 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1600 includes writemask/predicate registers 1615. For example, in some examples, there are 8 writemask/predicate registers (sometimes called k0 through k7) that are each 16-bit, 32-bit, 64-bit, or 128-bit in size. Writemask/predicate registers 1615 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1615 corresponds to a data element position of the destination. In other examples, the writemask/predicate registers 1615 are scalable and consists of a set number of enable bits for a given vector element (e.g., 8 enable bits per 64-bit vector element).

The register architecture 1600 includes a plurality of general-purpose registers 1625. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1600 includes scalar floating-point (FP) register file 1645 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1640 (e.g., EFLAGS, RFLAGS, etc.) store status and control information for arithmetic, compare, and system operations. For example, the one or more flag registers 1640 may store condition code information such as carry, parity, auxiliary carry, zero, sign, and overflow. In some examples, the one or more flag registers 1640 are called program status and control registers.

Segment registers 1620 contain segment points for use in accessing memory. In some examples, these registers are referenced by the names CS, DS, SS, ES, FS, and GS.

Model specific registers or machine specific registers (MSRs) 1635 control and report on processor performance. Most MSRs 1635 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1660 consist of control, status, and error reporting MSRs that are used to detect and report on hardware errors. Control register(s) 1655 (e.g., CR0-CR4) determine the operating mode of a processor (e.g., processor 770, 780, 738, 715, and/or 800) and the characteristics of a currently executing task. In some examples, MSRs 1635 are a subset of control registers 1655.

One or more instruction pointer register(s) 1630 store an instruction pointer value. Debug registers 1650 control and allow for the monitoring of a processor or core's debugging operations.

Memory (mem) management registers 1665 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1600 may, for example, be used in register file/memory, or physical register file(s) circuitry 1458.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

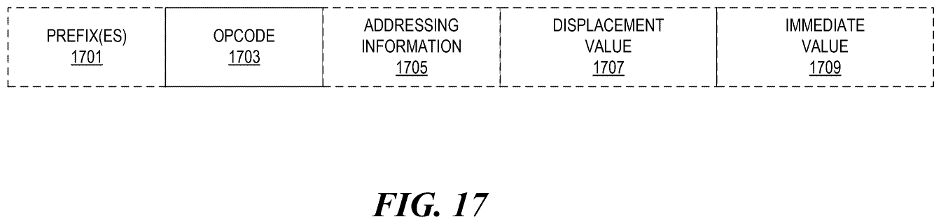

FIG. 17 illustrates examples of an instruction format. As illustrated, an instruction may include multiple components including, but not limited to, one or more fields for: one or more prefixes 1701, an opcode 1703, addressing information 1705 (e.g., register identifiers, memory addressing information, etc.), a displacement value 1707, and/or an immediate value 1709. Note that some instructions utilize some or all the fields of the format whereas others may only use the field for the opcode 1703. In some examples, the order illustrated is the order in which these fields are to be encoded, however, it should be appreciated that in other examples these fields may be encoded in a different order, combined, etc.

The prefix(es) field(s) 1701, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1703 is used to at least partially define the operation to be performed upon a decoding of the instruction. In some examples, a primary opcode encoded in the opcode field 1703 is one, two, or three bytes in length. In other examples, a primary opcode can be a different length. An additional 3-bit opcode field is sometimes encoded in another field.

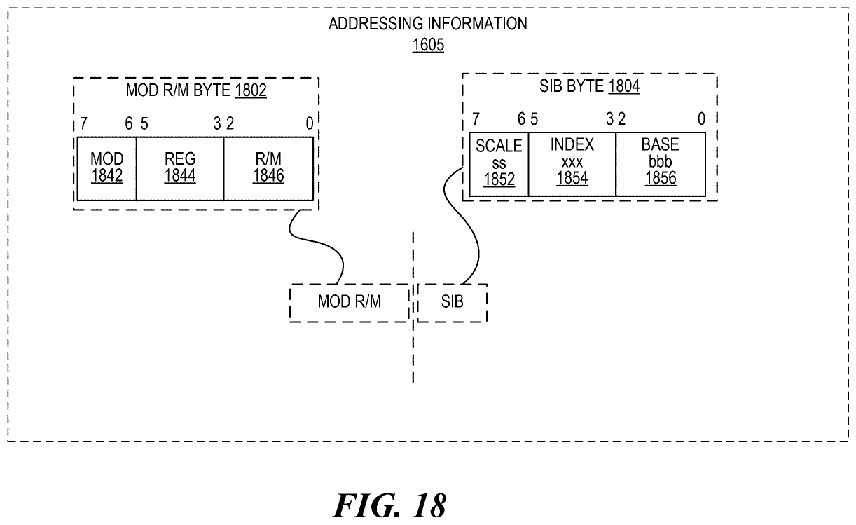

The addressing information field 1705 is used to address one or more operands of the instruction, such as a location in memory or one or more registers. FIG. 18 illustrates examples of the addressing information field 1705. In this illustration, an optional MOD R/M byte 1802 and an optional Scale, Index, Base (SIB) byte 1804 are shown. The MOD R/M byte 1802 and the SIB byte 1804 are used to encode up to two operands of an instruction, each of which is a direct register or effective memory address. Note that both of these fields are optional in that not all instructions include one or more of these fields. The MOD R/M byte 1802 includes a MOD field 1842, a register (reg) field 1844, and R/M field 1846.

The content of the MOD field 1842 distinguishes between memory access and non-memory access modes. In some examples, when the MOD field 1842 has a binary value of 11 (11b), a register-direct addressing mode is utilized, and otherwise a register-indirect addressing mode is used.

The register field 1844 may encode either the destination register operand or a source register operand or may encode an opcode extension and not be used to encode any instruction operand. The content of register field 1844, directly or through address generation, specifies the locations of a source or destination operand (either in a register or in memory). In some examples, the register field 1844 is supplemented with an additional bit from a prefix (e.g., prefix 1701) to allow for greater addressing.

The R/M field 1846 may be used to encode an instruction operand that references a memory address or may be used to encode either the destination register operand or a source register operand. Note the R/M field 1846 may be combined with the MOD field 1842 to dictate an addressing mode in some examples.

The SIB byte 1804 includes a scale field 1852, an index field 1854, and a base field 1856 to be used in the generation of an address. The scale field 1852 indicates a scaling factor. The index field 1854 specifies an index register to use. In some examples, the index field 1854 is supplemented with an additional bit from a prefix (e.g., prefix 1701) to allow for greater addressing. The base field 1856 specifies a base register to use. In some examples, the base field 1856 is supplemented with an additional bit from a prefix (e.g., prefix 1701) to allow for greater addressing. In practice, the content of the scale field 1852 allows for the scaling of the content of the index field 1854 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1707 provides this value. Additionally, in some examples, a displacement factor usage is encoded in the MOD field of the addressing information field 1705 that indicates a compressed displacement scheme for which a displacement value is calculated and stored in the displacement field 1707.

In some examples, the immediate value field 1709 specifies an immediate value for the instruction. An immediate value may be encoded as a 1-byte value, a 2-byte value, a 4-byte value, etc.

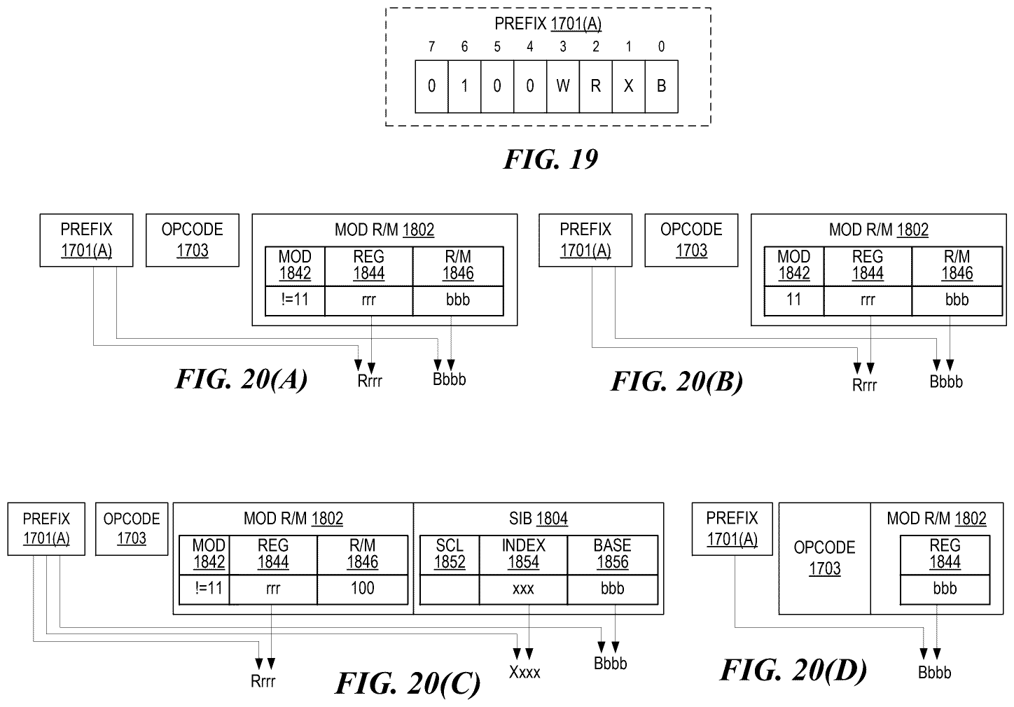

FIG. 19 illustrates examples of a first prefix 1701(A). In some examples, the first prefix 1701(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1701(A) may specify up to three registers using 3-bit fields depending on the format: 1) using the reg field 1844 and the R/M field 1846 of the MOD R/M byte 1802; 2) using the MOD R/M byte 1802 with the SIB byte 1804 including using the reg field 1844 and the base field 1856 and index field 1854; or 3) using the register field of an opcode.

In the first prefix 1701(A), bit positions of the payload byte 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1844 and MOD R/M R/M field 1846 alone can each only address 8 registers.

In the first prefix 1701(A), bit position 2 (R) may be an extension of the MOD R/M reg field 1844 and may be used to modify the MOD R/M reg field 1844 when that field encodes a general-purpose register, a 64-bit packed data register (e.g., an SSE register), or a control or debug register. R is ignored when MOD R/M byte 1802 specifies other registers or defines an extended opcode.

Bit position 1 (X) may modify the SIB byte index field 1854.

Bit position 0 (B) may modify the base in the MOD R/M R/M field 1846 or the SIB byte base field 1856; or it may modify the opcode register field used for accessing general purpose registers (e.g., general purpose registers 1625).

FIGS. 20A-20D illustrate examples of how the R, X, and B fields of the first prefix 1701(A) are used. FIG. 20A illustrates R and B from the first prefix 1701(A) being used to extend the reg field 1844 and R/M field 1846 of the MOD R/M byte 1802 when the SIB byte 18 04 is not used for memory addressing. FIG. 20B illustrates R and B from the first prefix 1701(A) being used to extend the reg field 1844 and R/M field 1846 of the MOD R/M byte 1802 when the SIB byte 18 04 is not used (register-register addressing). FIG. 20C illustrates R, X, and B from the first prefix 1701(A) being used to extend the reg field 1844 of the MOD R/M byte 1802 and the index field 1854 and base field 1856 when the SIB byte 18 04 being used for memory addressing. FIG. 20D illustrates B from the first prefix 1701(A) being used to extend the reg field 1844 of the MOD R/M byte 1802 when a register is encoded in the opcode 1703.

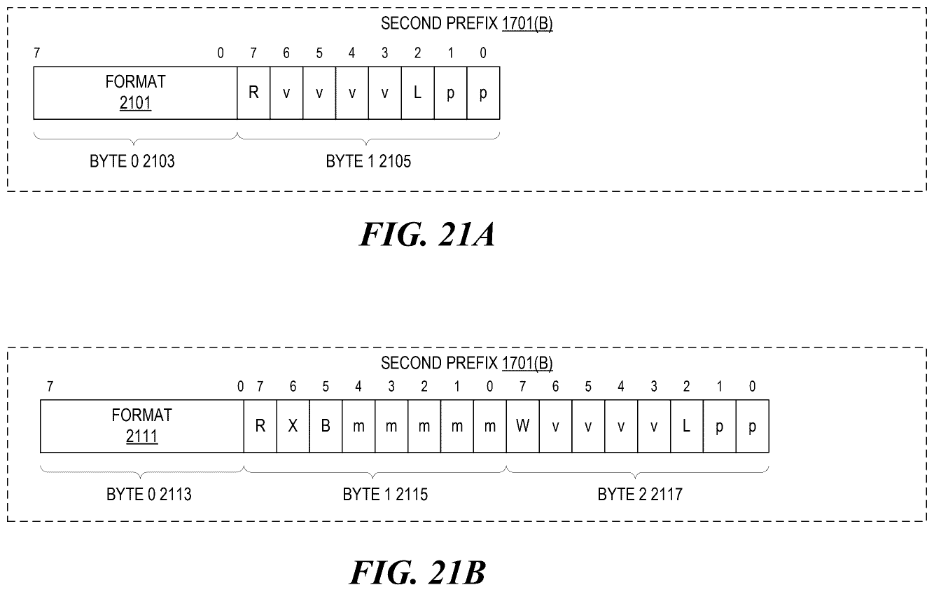

FIGS. 21A-21B illustrate examples of a second prefix 1701(B). In some examples, the second prefix 1701(B) is an example of a VEX prefix. The second prefix 1701(B) encoding allows instructions to have more than two operands, and allows SIMD vector registers (e.g., vector/SIMD registers 1610) to be longer than 64-bits (e.g., 128-bit and 256-bit). The use of the second prefix 1701(B) provides for three-operand (or more) syntax. For example, previous two-operand instructions performed operations such as A=A+B, which overwrites a source operand. The use of the second prefix 1701(B) enables operands to perform nondestructive operations such as A=B+C.

In some examples, the second prefix 1701(B) comes in two forms—a two-byte form and a three-byte form. The two-byte second prefix 1701(B) is used mainly for 128-bit, scalar, and some 256-bit instructions; while the three-byte second prefix 1701(B) provides a compact replacement of the first prefix 1701(A) and 3-byte opcode instructions.

FIG. 21A illustrates examples of a two-byte form of the second prefix 1701(B). In some examples, a format field 2101 (byte 0 2103) contains the value C5H. In some examples, byte 1 2105 includes an “R” value in bit[7]. This value is the complement of the “R” value of the first prefix 1701(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1846 to encode the instruction operand that references a memory address or encode either the destination register operand or a source register operand.

Instructions that use this prefix may use the MOD R/M reg field 1844 to encode either the destination register operand or a source register operand, or to be treated as an opcode extension and not used to encode any instruction operand.

For instruction syntax that support four operands, vvvv, the MOD R/M R/M field 1846 and the MOD R/M reg field 1844 encode three of the four operands. Bits[7:4] of the immediate value field 1709 are then used to encode the third source register operand.

FIG. 21B illustrates examples of a three-byte form of the second prefix 1701(B). In some examples, a format field 2111 (byte 0 2113) contains the value C4H. Byte 1 2115 includes in bits[7:5] “R,” “X,” and “B” which are the complements of the same values of the first prefix 1701(A). Bits[4:0] of byte 1 2115 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 2117 is used similar to W of the first prefix 1701(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1846 to encode the instruction operand that references a memory address or encode either the destination register operand or a source register operand.

Instructions that use this prefix may use the MOD R/M reg field 1844 to encode either the destination register operand or a source register operand, or to be treated as an opcode extension and not used to encode any instruction operand.

For instruction syntax that support four operands, vvvv, the MOD R/M R/M field 1846, and the MOD R/M reg field 1844 encode three of the four operands. Bits[7:4] of the immediate value field 1709 are then used to encode the third source register operand.

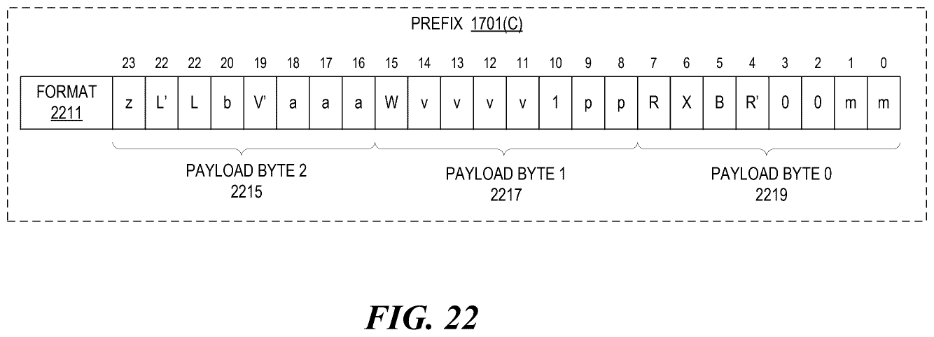

FIG. 22 illustrates examples of a third prefix 1701(C). In some examples, the third prefix 1701(C) is an example of an EVEX prefix. The third prefix 1701(C) is a four-byte prefix.

The third prefix 1701(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 16) or predication utilize this prefix. Opmask register allow for conditional processing or selection control. Opmask instructions, whose source/destination operands are opmask registers and treat the content of an opmask register as a single value, are encoded using the second prefix 1701(B).

The third prefix 1701(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1701(C) is a format field 2211 that has a value, in some examples, of 62H. Subsequent bytes are referred to as payload bytes 2215-2219 and collectively form a 24-bit value of P[23:0] providing specific capability in the form of one or more fields (detailed herein).

In some examples, P[1:0] of payload byte 2219 are identical to the low two mm bits. P[3:2] are reserved in some examples. Bit P[4] (R′) allows access to the high 16 vector register set when combined with P[7] and the MOD R/M reg field 1844. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1844 and MOD R/M R/M field 1846. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1701(A) and second prefix 1701(B) and may serve as an opcode extension bit or operand size promotion.

P[18:16] specify the index of a register in the opmask (writemask) registers (e.g., writemask/predicate registers 1615). In some examples, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other some examples, preserving the old value of each element of the destination where the corresponding mask bit has a 0. In contrast, when zeroing vector masks allow any set of elements in the destination to be zeroed during the execution of any operation (specified by the base operation and the augmentation operation); in some examples, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a nondestructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1701(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-k7 | 1^{st} Source |
| {k1} | aaa | k0-k7 | Opmask |

### Graphics Execution Units

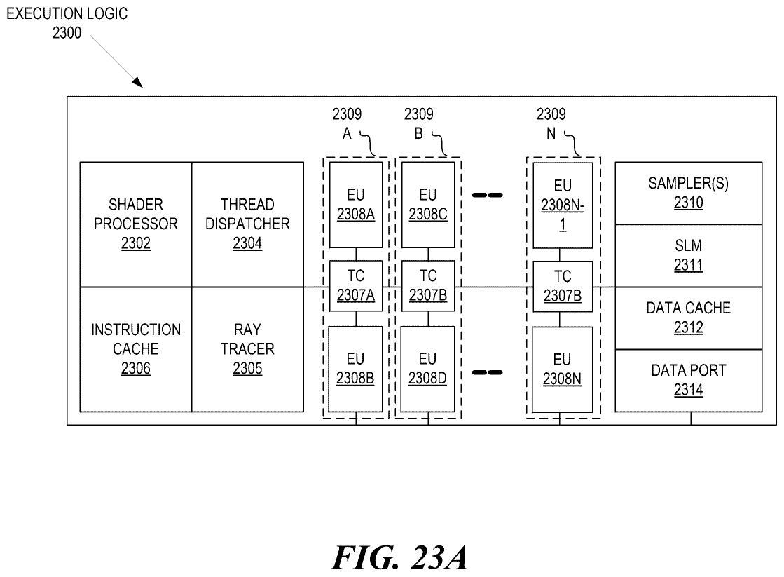

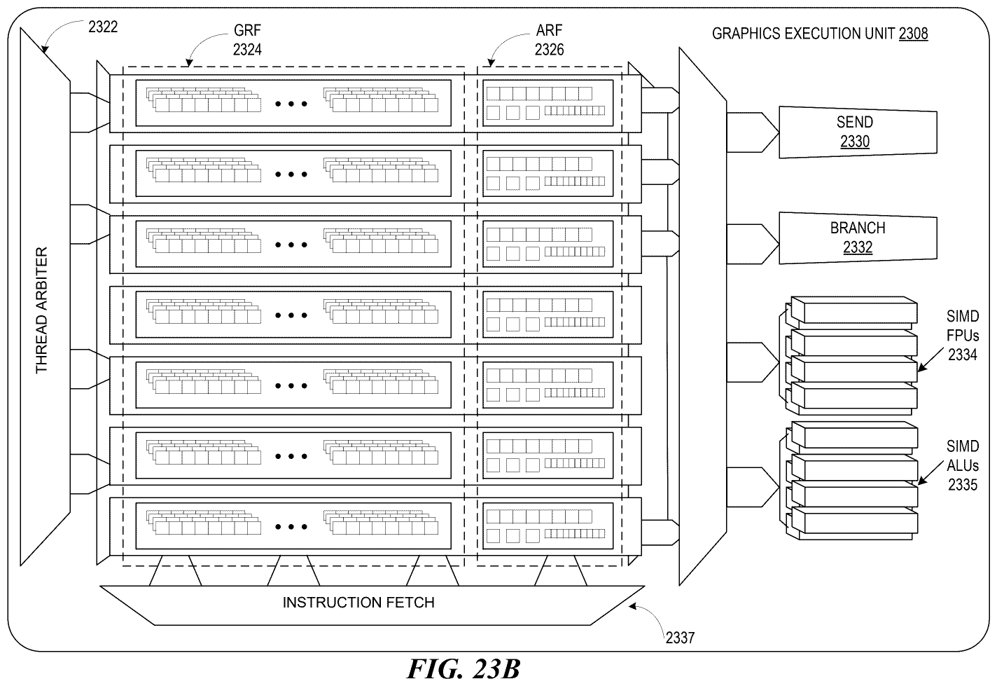

FIGS. 23A-23B illustrate thread execution logic 2300 including an array of processing elements employed in a graphics processor core according to examples described herein. Elements of FIGS. 23A-23B having the same reference numbers (or names) as the elements of any other figure herein can operate or function in any manner similar to that described elsewhere herein, but are not limited to such. FIG. 23A is representative of an execution unit within a general-purpose graphics processor, while FIG. 23B is representative of an execution unit that may be used within a compute accelerator.

As illustrated in FIG. 23A, in some examples thread execution logic 2300 includes a shader processor 2302, a thread dispatcher 2304, instruction cache 2306, a scalable execution unit array including a plurality of execution units 2308A-2308N, a sampler 2310, shared local memory 2311, a data cache 2312, and a data port 2314. In some examples the scalable execution unit array can dynamically scale by enabling or disabling one or more execution units (e.g., any of execution units 2308A, 2308B, 2308C, 2308D, through 2308N-1 and 2308N) based on the computational requirements of a workload. In some examples the included components are interconnected via an interconnect fabric that links to each of the components. In some examples, thread execution logic 2300 includes one or more connections to memory, such as system memory or cache memory, through one or more of instruction cache 2306, data port 2314, sampler 2310, and execution units 2308A-2308N. In some examples, each execution unit (e.g., 2308A) is a stand-alone programmable general-purpose computational unit that is capable of executing multiple simultaneous hardware threads while processing multiple data elements in parallel for each thread. In various examples, the array of execution units 2308A-2308N is scalable to include any number individual execution units.

In some examples, the execution units 2308A-2308N are primarily used to execute shader programs. A shader processor 2302 can process the various shader programs and dispatch execution threads associated with the shader programs via a thread dispatcher 2304. In some examples the thread dispatcher includes logic to arbitrate thread initiation requests from the graphics and media pipelines and instantiate the requested threads on one or more execution unit in the execution units 2308A-2308N. For example, a geometry pipeline can dispatch vertex, tessellation, or geometry shaders to the thread execution logic for processing. In some examples, thread dispatcher 2304 can also process runtime thread spawning requests from the executing shader programs.

In some examples, the execution units 2308A-2308N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 2308A-2308N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 2308A-2308N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 2308A-2308N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 2308A-2308N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 2309A-2309N having thread control logic (2307A-2307N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 2309A-2309N includes at least two execution units. For example, fused execution unit 2309A includes a first EU 2308A, second EU 2308B, and thread control logic 2307A that is common to the first EU 2308A and the second EU 2308B. The thread control logic 2307A controls threads executed on the fused graphics execution unit 2309A, allowing each EU within the fused execution units 2309A-2309N to execute using a common instruction pointer register.

One or more internal instruction caches (e.g., 2306) are included in the thread execution logic 2300 to cache thread instructions for the execution units. In some examples, one or more data caches (e.g., 2312) are included to cache thread data during thread execution. Threads executing on the execution logic 2300 can also store explicitly managed data in the shared local memory 2311. In some examples, a sampler 2310 is included to provide texture sampling for 3D operations and media sampling for media operations. In some examples, sampler 2310 includes specialized texture or media sampling functionality to process texture or media data during the sampling process before providing the sampled data to an execution unit.

During execution, the graphics and media pipelines send thread initiation requests to thread execution logic 2300 via thread spawning and dispatch logic. Once a group of geometric objects has been processed and rasterized into pixel data, pixel processor logic (e.g., pixel shader logic, fragment shader logic, etc.) within the shader processor 2302 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 2302 then executes an application programming interface (API)-supplied pixel or fragment shader program. To execute the shader program, the shader processor 2302 dispatches threads to an execution unit (e.g., 2308A) via thread dispatcher 2304. In some examples, shader processor 2302 uses texture sampling logic in the sampler 2310 to access texture data in texture maps stored in memory. Arithmetic operations on the texture data and the input geometry data compute pixel color data for each geometric fragment, or discards one or more pixels from further processing.

In some examples, the data port 2314 provides a memory access mechanism for the thread execution logic 2300 to output processed data to memory for further processing on a graphics processor output pipeline. In some examples, the data port 2314 includes or couples to one or more cache memories (e.g., data cache 2312) to cache data for memory access via the data port.

In some examples, the execution logic 2300 can also include a ray tracer 2305 that can provide ray tracing acceleration functionality. The ray tracer 2305 can support a ray tracing instruction set that includes instructions/functions for ray generation.

FIG. 23B illustrates exemplary internal details of an execution unit 2308, according to examples. A graphics execution unit 2308 can include an instruction fetch unit 2337, a general register file array (GRF) 2324, an architectural register file array (ARF) 2326, a thread arbiter 2322, a send unit 2330, a branch unit 2332, a set of SIMD floating point units (FPUs) 2334, and in some examples a set of dedicated integer SIMD ALUs 2335. The GRF 2324 and ARF 2326 includes the set of general register files and architecture register files associated with each simultaneous hardware thread that may be active in the graphics execution unit 2308. In some examples, per thread architectural state is maintained in the ARF 2326, while data used during thread execution is stored in the GRF 2324. The execution state of each thread, including the instruction pointers for each thread, can be held in thread-specific registers in the ARF 2326.

In some examples the graphics execution unit 2308 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 2308 is not limited to the number of hardware threads, and multiple logical threads can be assigned to each hardware thread.

In some examples, the graphics execution unit 2308 can co-issue multiple instructions, which may each be different instructions. The thread arbiter 2322 of the graphics execution unit thread 2308 can dispatch the instructions to one of the send unit 2330, branch unit 2332, or SIMD FPU(s) 2334 for execution. Each execution thread can access 128 general-purpose registers within the GRF 2324, where each register can store 32 bytes, accessible as a SIMD 8-element vector of 32-bit data elements. In some examples, each execution unit thread has access to 4 Kbytes within the GRF 2324, although examples are not so limited, and greater or fewer register resources may be provided in other examples. In some examples the graphics execution unit 2308 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 2324 can store a total of 28 Kbytes. Where 16 threads may access 4 Kbytes, the GRF 2324 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 2330. In some examples, branch instructions are dispatched to a dedicated branch unit 2332 to facilitate SIMD divergence and eventual convergence.

In some examples the graphics execution unit 2308 includes one or more SIMD floating point units (FPU(s)) 2334 to perform floating-point operations. In some examples, the FPU(s) 2334 also support integer computation. In some examples the FPU(s) 2334 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 2335 are also present, and may be specifically optimized to perform operations associated with machine learning computations.

In some examples, arrays of multiple instances of the graphics execution unit 2308 can be instantiated in a graphics sub-core grouping (e.g., a sub-slice). For scalability, product architects can choose the exact number of execution units per sub-core grouping. In some examples the execution unit 2308 can execute instructions across a plurality of execution channels. In a further example, each thread executed on the graphics execution unit 2308 is executed on a different channel.

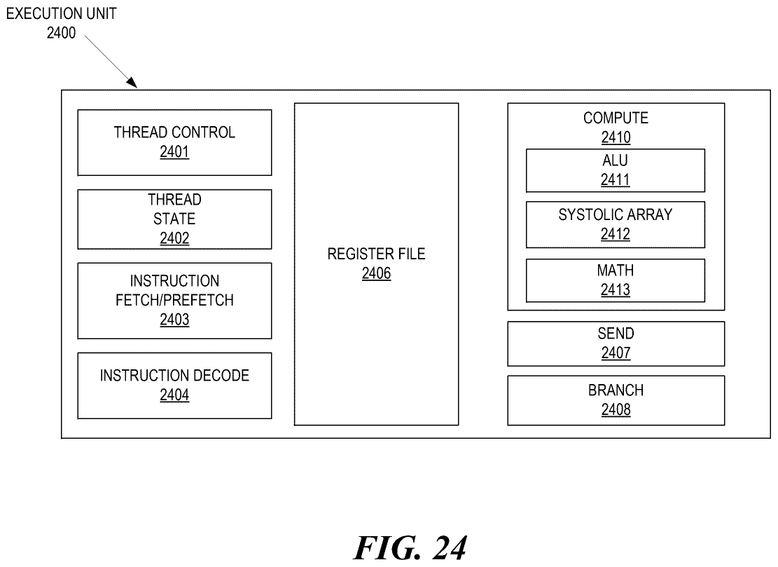

FIG. 24 illustrates an additional execution unit 2400, according to an example. In some examples, the execution unit 2400 includes a thread control unit 2401, a thread state unit 2402, an instruction fetch/prefetch unit 2403, and an instruction decode unit 2404. The execution unit 2400 additionally includes a register file 2406 that stores registers that can be assigned to hardware threads within the execution unit. The execution unit 2400 additionally includes a send unit 2407 and a branch unit 2408. In some examples, the send unit 2407 and branch unit 2408 can operate similarly as the send unit 2330 and a branch unit 2332 of the graphics execution unit 2308 of FIG. 23B.

The execution unit 2400 also includes a compute unit 2410 that includes multiple different types of functional units. In some examples the compute unit 2410 includes an ALU unit 2411 that includes an array of arithmetic logic units. The ALU unit 2411 can be configured to perform 64-bit, 32-bit, and 16-bit integer and floating point operations. Integer and floating point operations may be performed simultaneously. The compute unit 2410 can also include a systolic array 2412, and a math unit 2413. The systolic array 2412 includes a W wide and D deep network of data processing units that can be used to perform vector or other data-parallel operations in a systolic manner. In some examples the systolic array 2412 can be configured to perform matrix operations, such as matrix dot product operations. In some examples the systolic array 2412 support 16-bit floating point operations, as well as 8-bit and 4-bit integer operations. In some examples the systolic array 2412 can be configured to accelerate machine learning operations. In such examples, the systolic array 2412 can be configured with support for the bfloat 16-bit floating point format. In some examples, a math unit 2413 can be included to perform a specific subset of mathematical operations in an efficient and lower-power manner than the ALU unit 2411. The math unit 2413 can include a variant of math logic that may be found in shared function logic of a graphics processing engine provided by other examples. In some examples the math unit 2413 can be configured to perform 32-bit and 64-bit floating point operations.

The thread control unit 2401 includes logic to control the execution of threads within the execution unit. The thread control unit 2401 can include thread arbitration logic to start, stop, and preempt execution of threads within the execution unit 2400. The thread state unit 2402 can be used to store thread state for threads assigned to execute on the execution unit 2400. Storing the thread state within the execution unit 2400 enables the rapid pre-emption of threads when those threads become blocked or idle. The instruction fetch/prefetch unit 2403 can fetch instructions from an instruction cache of higher level execution logic (e.g., instruction cache 2306 as in FIG. 23A). The instruction fetch/prefetch unit 2403 can also issue prefetch requests for instructions to be loaded into the instruction cache based on an analysis of currently executing threads. The instruction decode unit 2404 can be used to decode instructions to be executed by the compute units. In some examples, the instruction decode unit 2404 can be used as a secondary decoder to decode complex instructions into constituent micro-operations.

The execution unit 2400 additionally includes a register file 2406 that can be used by hardware threads executing on the execution unit 2400. Registers in the register file 2406 can be divided across the logic used to execute multiple simultaneous threads within the compute unit 2410 of the execution unit 2400. The number of logical threads that may be executed by the graphics execution unit 2400 is not limited to the number of hardware threads, and multiple logical threads can be assigned to each hardware thread. The size of the register file 2406 can vary across examples based on the number of supported hardware threads. In some examples, register renaming may be used to dynamically allocate registers to hardware threads.

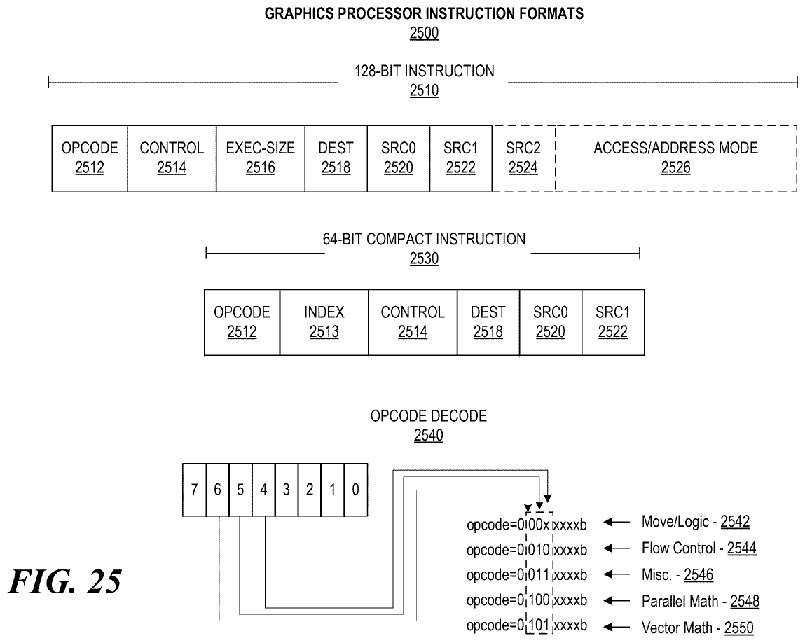

FIG. 25 is a block diagram illustrating a graphics processor instruction formats 2500 according to some examples. In one or more example, the graphics processor execution units support an instruction set having instructions in multiple formats. The solid lined boxes illustrate the components that are generally included in an execution unit instruction, while the dashed lines include components that are optional or that are only included in a sub-set of the instructions. In some examples, instruction format 2500 described and illustrated are macro-instructions, in that they are instructions supplied to the execution unit, as opposed to micro-operations resulting from instruction decode once the instruction is processed.

In some examples, the graphics processor execution units natively support instructions in a 128-bit instruction format 2510. A 64-bit compacted instruction format 2530 is available for some instructions based on the selected instruction, instruction options, and number of operands. The native 128-bit instruction format 2510 provides access to all instruction options, while some options and operations are restricted in the 64-bit format 2530. The native instructions available in the 64-bit format 2530 vary by example. In some examples, the instruction is compacted in part using a set of index values in an index field 2513. The execution unit hardware references a set of compaction tables based on the index values and uses the compaction table outputs to reconstruct a native instruction in the 128-bit instruction format 2510. Other sizes and formats of instruction can be used.

For each format, instruction opcode 2512 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some examples, instruction control field 2514 enables control over certain execution options, such as channels selection (e.g., predication) and data channel order (e.g., swizzle). For instructions in the 128-bit instruction format 2510 an exec-size field 2516 limits the number of data channels that will be executed in parallel. In some examples, exec-size field 2516 is not available for use in the 64-bit compact instruction format 2530.

Some execution unit instructions have up to three operands including two source operands, src0 2520, src1 2522, and one destination 2518. In some examples, the execution units support dual destination instructions, where one of the destinations is implied. Data manipulation instructions can have a third source operand (e.g., SRC2 2524), where the instruction opcode 2512 determines the number of source operands. An instruction's last source operand can be an immediate (e.g., hard-coded) value passed with the instruction.

In some examples, the 128-bit instruction format 2510 includes an access/address mode field 2526 specifying, for example, whether direct register addressing mode or indirect register addressing mode is used. When direct register addressing mode is used, the register address of one or more operands is directly provided by bits in the instruction.

In some examples, the 128-bit instruction format 2510 includes an access/address mode field 2526, which specifies an address mode and/or an access mode for the instruction. In some examples the access mode is used to define a data access alignment for the instruction. Some examples support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In some examples, the address mode portion of the access/address mode field 2526 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some examples instructions are grouped based on opcode 2512 bit-fields to simplify Opcode decode 2540. For an 8-bit opcode, bits 4, 5, and 6 allow the execution unit to determine the type of opcode. The precise opcode grouping shown is merely an example. In some examples, a move and logic opcode group 2542 includes data movement and logic instructions (e.g., move (mov), compare (cmp)). In some examples, move and logic group 2542 shares the five most significant bits (MSB), where move (mov) instructions are in the form of 0000xxxxb and logic instructions are in the form of 0001xxxxb. A flow control instruction group 2544 (e.g., call, jump (jmp)) includes instructions in the form of 0010xxxxb (e.g., 0x20). A miscellaneous instruction group 2546 includes a mix of instructions, including synchronization instructions (e.g., wait, send) in the form of 0011xxxxb (e.g., 0x30). A parallel math instruction group 2548 includes component-wise arithmetic instructions (e.g., add, multiply (mul)) in the form of 0100xxxxb (e.g., 0x40). The parallel math group 2548 performs the arithmetic operations in parallel across data channels. The vector math group 2550 includes arithmetic instructions (e.g., dp4) in the form of 0101xxxxb (e.g., 0x50). The vector math group performs arithmetic such as dot product calculations on vector operands. The illustrated opcode decode 2540, in some examples, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

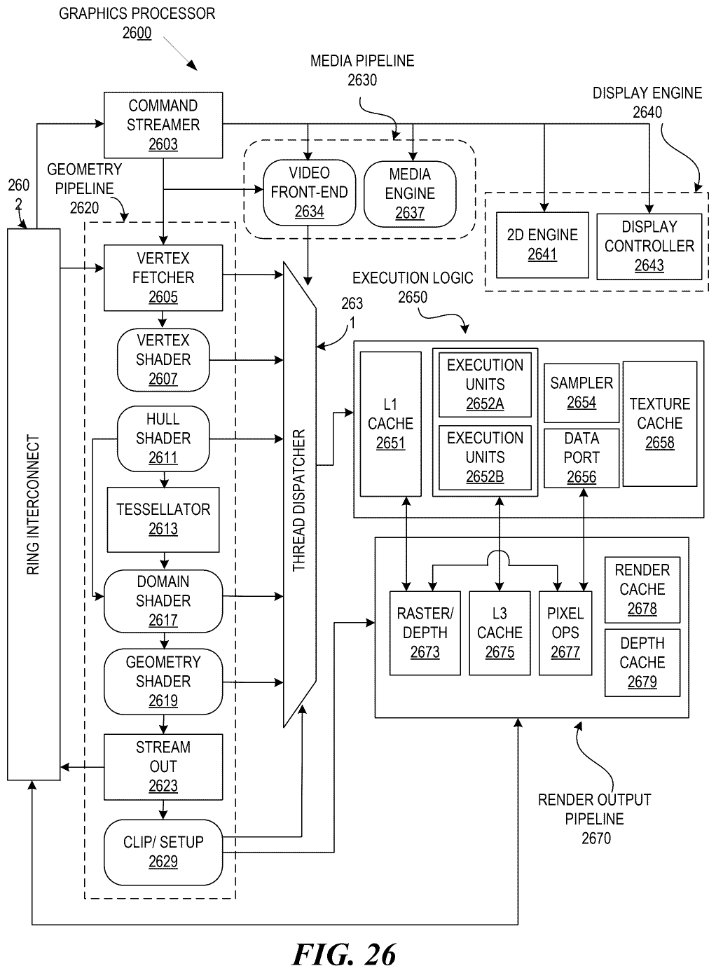

FIG. 26 is a block diagram of another example of a graphics processor 2600. Elements of FIG. 26 having the same reference numbers (or names) as the elements of any other figure herein can operate or function in any manner similar to that described elsewhere herein, but are not limited to such.

In some examples, graphics processor 2600 includes a geometry pipeline 2620, a media pipeline 2630, a display engine 2640, thread execution logic 2650, and a render output pipeline 2670. In some examples, graphics processor 2600 is a graphics processor within a multi-core processing system that includes one or more general-purpose processing cores. The graphics processor is controlled by register writes to one or more control registers (not shown) or via commands issued to graphics processor 2600 via a ring interconnect 2602. In some examples, ring interconnect 2602 couples graphics processor 2600 to other processing components, such as other graphics processors or general-purpose processors. Commands from ring interconnect 2602 are interpreted by a command streamer 2603, which supplies instructions to individual components of the geometry pipeline 2620 or the media pipeline 2630.

In some examples, command streamer 2603 directs the operation of a vertex fetcher 2605 that reads vertex data from memory and executes vertex-processing commands provided by command streamer 2603. In some examples, vertex fetcher 2605 provides vertex data to a vertex shader 2607, which performs coordinate space transformation and lighting operations to each vertex. In some examples, vertex fetcher 2605 and vertex shader 2607 execute vertex-processing instructions by dispatching execution threads to execution units 2652A-2652B via a thread dispatcher 2631.

In some examples, execution units 2652A-2652B are an array of vector processors having an instruction set for performing graphics and media operations. In some examples, execution units 2652A-2652B have an attached L1 cache 2651 that is specific for each array or shared between the arrays. The cache can be configured as a data cache, an instruction cache, or a single cache that is partitioned to contain data and instructions in different partitions.

In some examples, geometry pipeline 2620 includes tessellation components to perform hardware-accelerated tessellation of 3D objects. In some examples, a programmable hull shader 2611 configures the tessellation operations. A programmable domain shader 2617 provides backend evaluation of tessellation output. A tessellator 2613 operates at the direction of hull shader 2611 and contains special purpose logic to generate a set of detailed geometric objects based on a coarse geometric model that is provided as input to geometry pipeline 2620. In some examples, if tessellation is not used, tessellation components (e.g., hull shader 2611, tessellator 2613, and domain shader 2617) can be bypassed.

In some examples, complete geometric objects can be processed by a geometry shader 2619 via one or more threads dispatched to execution units 2652A-2652B, or can proceed directly to the clipper 2629. In some examples, the geometry shader operates on entire geometric objects, rather than vertices or patches of vertices as in previous stages of the graphics pipeline. If the tessellation is disabled the geometry shader 2619 receives input from the vertex shader 2607. In some examples, geometry shader 2619 is programmable by a geometry shader program to perform geometry tessellation if the tessellation units are disabled.

Before rasterization, a clipper 2629 processes vertex data. The clipper 2629 may be a fixed function clipper or a programmable clipper having clipping and geometry shader functions. In some examples, a rasterizer and depth test component 2673 in the render output pipeline 2670 dispatches pixel shaders to convert the geometric objects into per pixel representations. In some examples, pixel shader logic is included in thread execution logic 2650. In some examples, an application can bypass the rasterizer and depth test component 2673 and access un-rasterized vertex data via a stream out unit 2623.

The graphics processor 2600 has an interconnect bus, interconnect fabric, or some other interconnect mechanism that allows data and message passing amongst the major components of the processor. In some examples, execution units 2652A-2652B and associated logic units (e.g., L1 cache 2651, sampler 2654, texture cache 2658, etc.) interconnect via a data port 2656 to perform memory access and communicate with render output pipeline components of the processor. In some examples, sampler 2654, caches 2651, 2658 and execution units 2652A-2652B each have separate memory access paths. In some examples the texture cache 2658 can also be configured as a sampler cache.

In some examples, render output pipeline 2670 contains a rasterizer and depth test component 2673 that converts vertex-based objects into an associated pixel-based representation. In some examples, the rasterizer logic includes a windower/masker unit to perform fixed function triangle and line rasterization. An associated render cache 2678 and depth cache 2679 are also available in some examples. A pixel operations component 2677 performs pixel-based operations on the data, though in some instances, pixel operations associated with 2D operations (e.g., bit block image transfers with blending) are performed by the 2D engine 2641, or substituted at display time by the display controller 2643 using overlay display planes. In some examples, a shared L3 cache 2675 is available to all graphics components, allowing the sharing of data without the use of main system memory.

In some examples, graphics processor media pipeline 2630 includes a media engine 2637 and a video front-end 2634. In some examples, video front-end 2634 receives pipeline commands from the command streamer 2603. In some examples, media pipeline 2630 includes a separate command streamer. In some examples, video front-end 2634 processes media commands before sending the command to the media engine 2637. In some examples, media engine 2637 includes thread spawning functionality to spawn threads for dispatch to thread execution logic 2650 via thread dispatcher 2631.

In some examples, graphics processor 2600 includes a display engine 2640. In some examples, display engine 2640 is external to processor 2600 and couples with the graphics processor via the ring interconnect 2602, or some other interconnect bus or fabric. In some examples, display engine 2640 includes a 2D engine 2641 and a display controller 2643. In some examples, display engine 2640 contains special purpose logic capable of operating independently of the 3D pipeline. In some examples, display controller 2643 couples with a display device (not shown), which may be a system integrated display device, as in a laptop computer, or an external display device attached via a display device connector.

In some examples, the geometry pipeline 2620 and media pipeline 2630 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

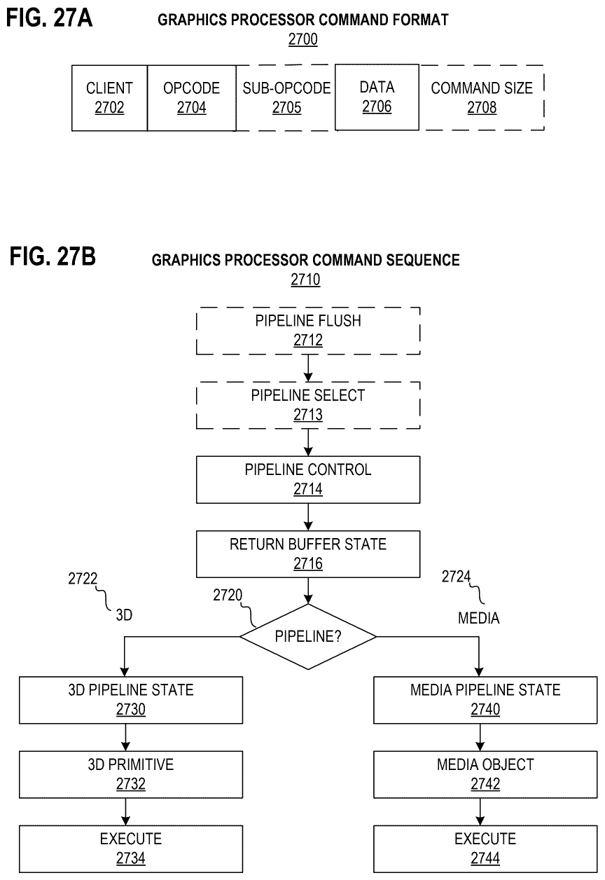

FIG. 27A is a block diagram illustrating a graphics processor command format 2700 according to some examples. FIG. 27B is a block diagram illustrating a graphics processor command sequence 2710 according to an example. The solid lined boxes in FIG. 27A illustrate the components that are generally included in a graphics command while the dashed lines include components that are optional or that are only included in a sub-set of the graphics commands. The exemplary graphics processor command format 2700 of FIG. 27A includes data fields to identify a client 2702, a command operation code (opcode) 2704, and data 2706 for the command. A sub-opcode 2705 and a command size 2708 are also included in some commands.

In some examples, client 2702 specifies the client unit of the graphics device that processes the command data. In some examples, a graphics processor command parser examines the client field of each command to condition the further processing of the command and route the command data to the appropriate client unit. In some examples, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 2704 and, if present, sub-opcode 2705 to determine the operation to perform. The client unit performs the command using information in data field 2706. For some commands, an explicit command size 2708 is expected to specify the size of the command. In some examples, the command parser automatically determines the size of at least some of the commands based on the command opcode. In some examples commands are aligned via multiples of a double word. Other command formats can be used.

The flow diagram in FIG. 27B illustrates an exemplary graphics processor command sequence 2710. In some examples, software or firmware of a data processing system that features an example of a graphics processor uses a version of the command sequence shown to set up, execute, and terminate a set of graphics operations. A sample command sequence is shown and described for purposes of example only as examples are not limited to these specific commands or to this command sequence. Moreover, the commands may be issued as batch of commands in a command sequence, such that the graphics processor will process the sequence of commands in at least partially concurrence.

In some examples, the graphics processor command sequence 2710 may begin with a pipeline flush command 2712 to cause any active graphics pipeline to complete the currently pending commands for the pipeline. In some examples, the 3D pipeline 2722 and the media pipeline 2724 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some examples, pipeline flush command 2712 can be used for pipeline synchronization or before placing the graphics processor into a low power state.

In some examples, a pipeline select command 2713 is used when a command sequence requires the graphics processor to explicitly switch between pipelines. In some examples, a pipeline select command 2713 is required only once within an execution context before issuing pipeline commands unless the context is to issue commands for both pipelines. In some examples, a pipeline flush command 2712 is required immediately before a pipeline switch via the pipeline select command 2713.

In some examples, a pipeline control command 2714 configures a graphics pipeline for operation and is used to program the 3D pipeline 2722 and the media pipeline 2724. In some examples, pipeline control command 2714 configures the pipeline state for the active pipeline. In some examples, the pipeline control command 2714 is used for pipeline synchronization and to clear data from one or more cache memories within the active pipeline before processing a batch of commands.

In some examples, return buffer state commands 2716 are used to configure a set of return buffers for the respective pipelines to write data. Some pipeline operations require the allocation, selection, or configuration of one or more return buffers into which the operations write intermediate data during processing. In some examples, the graphics processor also uses one or more return buffers to store output data and to perform cross thread communication. In some examples, the return buffer state 2716 includes selecting the size and number of return buffers to use for a set of pipeline operations.

The remaining commands in the command sequence differ based on the active pipeline for operations. Based on a pipeline determination 2720, the command sequence is tailored to the 3D pipeline 2722 beginning with the 3D pipeline state 2730 or the media pipeline 2724 beginning at the media pipeline state 2740.

The commands to configure the 3D pipeline state 2730 include 3D state setting commands for vertex buffer state, vertex element state, constant color state, depth buffer state, and other state variables that are to be configured before 3D primitive commands are processed. The values of these commands are determined at least in part based on the particular 3D API in use. In some examples, 3D pipeline state 2730 commands are also able to selectively disable or bypass certain pipeline elements if those elements will not be used.

In some examples, 3D primitive 2732 command is used to submit 3D primitives to be processed by the 3D pipeline. Commands and associated parameters that are passed to the graphics processor via the 3D primitive 2732 command are forwarded to the vertex fetch function in the graphics pipeline. The vertex fetch function uses the 3D primitive 2732 command data to generate vertex data structures. The vertex data structures are stored in one or more return buffers. In some examples, 3D primitive 2732 command is used to perform vertex operations on 3D primitives via vertex shaders. To process vertex shaders, 3D pipeline 2722 dispatches shader execution threads to graphics processor execution units.

In some examples, 3D pipeline 2722 is triggered via an execute 2734 command or event. In some examples, a register write triggers command execution. In some examples execution is triggered via a ‘go’ or ‘kick’ command in the command sequence. In some examples, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some examples, the graphics processor command sequence 2710 follows the media pipeline 2724 path when performing media operations. In general, the specific use and manner of programming for the media pipeline 2724 depends on the media or compute operations to be performed. Specific media decode operations may be offloaded to the media pipeline during media decode. In some examples, the media pipeline can also be bypassed and media decode can be performed in whole or in part using resources provided by one or more general-purpose processing cores. In some examples, the media pipeline also includes elements for general-purpose graphics processor unit (GPGPU) operations, where the graphics processor is used to perform SIMD vector operations using computational shader programs that are not explicitly related to the rendering of graphics primitives.

In some examples, media pipeline 2724 is configured in a similar manner as the 3D pipeline 2722. A set of commands to configure the media pipeline state 2740 are dispatched or placed into a command queue before the media object commands 2742. In some examples, commands for the media pipeline state 2740 include data to configure the media pipeline elements that will be used to process the media objects. This includes data to configure the video decode and video encode logic within the media pipeline, such as encode or decode format. In some examples, commands for the media pipeline state 2740 also support the use of one or more pointers to “indirect” state elements that contain a batch of state settings.

In some examples, media object commands 2742 supply pointers to media objects for processing by the media pipeline. The media objects include memory buffers containing video data to be processed. In some examples, all media pipeline states must be valid before issuing a media object command 2742. Once the pipeline state is configured and media object commands 2742 are queued, the media pipeline 2724 is triggered via an execute command 2744 or an equivalent execute event (e.g., register write). Output from media pipeline 2724 may then be post processed by operations provided by the 3D pipeline 2722 or the media pipeline 2724. In some examples, GPGPU operations are configured and executed in a similar manner as media operations.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

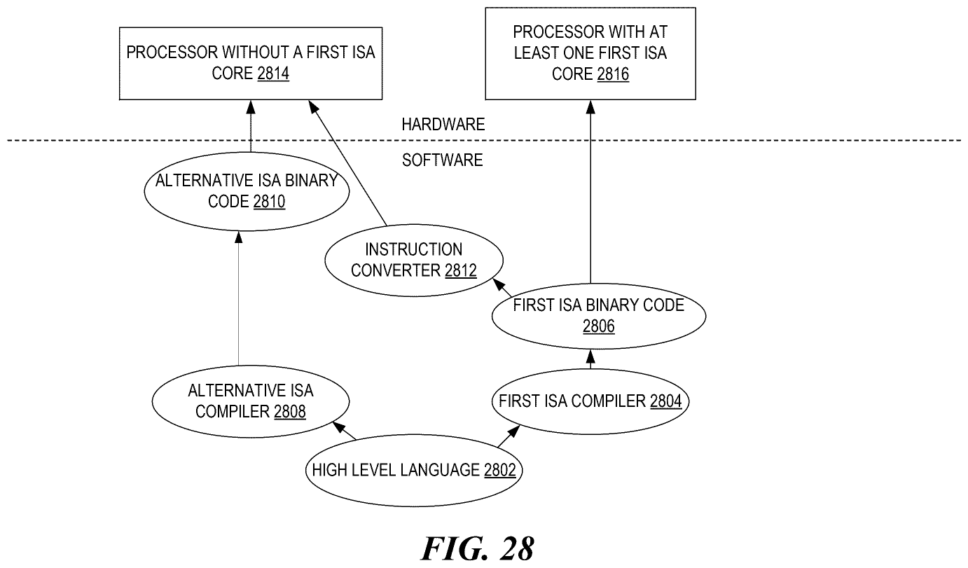

FIG. 28 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 28 shows a program in a high-level language 2802 may be compiled using a first ISA compiler 2804 to generate first ISA binary code 2806 that may be natively executed by a processor with at least one first ISA core 2816. The processor with at least one first ISA core 2816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2804 represents a compiler that is operable to generate first ISA binary code 2806 (e.g., object code) that can, with or without additional linkage processing, be executed on the processor with at least one first ISA core 2816. Similarly, FIG. 28 shows the program in the high-level language 2802 may be compiled using an alternative ISA compiler 2808 to generate alternative ISA binary code 2810 that may be natively executed by a processor without a first ISA core 2814. The instruction converter 2812 is used to convert the first ISA binary code 2806 into code that may be natively executed by the processor without a first ISA core 2814. This converted code is not necessarily to be the same as the alternative ISA binary code 2810; however, the converted code will accomplish the general operation and be made up of instructions from the alternative ISA. Thus, the instruction converter 2812 represents software, firmware, hardware, or a combination thereof that, through emulation, simulation or any other process, allows a processor or other electronic device that does not have a first ISA processor or core to execute the first ISA binary code 2806.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

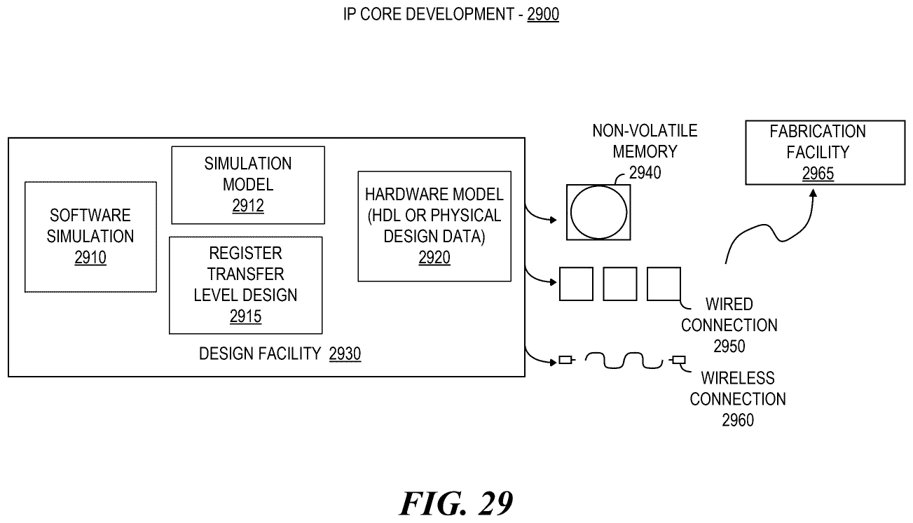

FIG. 29 is a block diagram illustrating an IP core development system 2900 that may be used to manufacture an integrated circuit to perform operations according to some examples. The IP core development system 2900 may be used to generate modular, re-usable designs that can be incorporated into a larger design or used to construct an entire integrated circuit (e.g., an SOC integrated circuit). A design facility 2930 can generate a software simulation 2910 of an IP core design in a high-level programming language (e.g., C/C++). The software simulation 2910 can be used to design, test, and verify the behavior of the IP core using a simulation model 2912. The simulation model 2912 may include functional, behavioral, and/or timing simulations. A register transfer level (RTL) design 2915 can then be created or synthesized from the simulation model 2912. The RTL design 2915 is an abstraction of the behavior of the integrated circuit that models the flow of digital signals between hardware registers, including the associated logic performed using the modeled digital signals. In addition to an RTL design 2915, lower-level designs at the logic level or transistor level may also be created, designed, or synthesized. Thus, the particular details of the initial design and simulation may vary.

The RTL design 2915 or equivalent may be further synthesized by the design facility into a hardware model 2920, which may be in a hardware description language (HDL), or some other representation of physical design data. The HDL may be further simulated or tested to verify the IP core design. The IP core design can be stored for delivery to a 3^{rd} party fabrication facility 2965 using non-volatile memory 2940 (e.g., hard disk, flash memory, or any non-volatile storage medium). Alternatively, the IP core design may be transmitted (e.g., via the Internet) over a wired connection 2950 or wireless connection 2960. The fabrication facility 2965 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. A processing element comprising:
a plurality of registers, at least one register of the plurality of registers configured to store a value x;
an arithmetic logic unit (ALU); and
circuitry configured to:
load a shared representation of the value x to a register file, wherein the shared representation is based on n shares, where n is greater than or equal to 2;
cause the shared representation of the value x to be input to the ALU from the register file;
cause, at the ALU, the shared representation of the value x to be recombined to a single representation of the value x;
cause, at the ALU, an operation using the single representation of the value x to generate a value y result;
cause, at the ALU, the value y result to be split to a shared representation based on n shares; and
cause the shared representation of the value y result to be stored to n registers from among the plurality of registers or cause a single representation of the value y result to be stored to a register from among the plurality of registers.

2. The processing element of claim 1, wherein the operation using the single representation of the value x to generate a value y result comprises a cryptographic operation, and wherein the value x is a secret key and the value y result is a cryptographic signature.

3. The processing element of claim 1, the shared representation of the value x comprises n Boolean shares, wherein the shared representation of the value x to be recombined to the single representation of the value x is via an n operand XOR result generated based on the n Boolean shares.

4. The processing element of claim 1, the shared representation of the value x comprises n arithmetic shares, wherein the shared representation of the value x to be recombined to the single representation of the value x is via an n operand addition result generated based on the n arithmetic shares.

5. The processing element of claim 1, wherein the shared representation of the value x is loaded from n registers from among the plurality of registers.

6. The processing element of claim 1, wherein the circuitry is further configured to:
convert the value x to the shared representation of the value x prior to loading the shared representation of the value x to the register file.

7. The processing element of claim 1, comprising the single representation of the value x has an m-bit integer value of z that is to be casted to a floating point representation f, where m is any whole, positive number, wherein the circuitry is further configured to:
obtain a random number r to be generated such that z+r is greater than 0; and
determine the floating point representation f based on float(z+r)−f−float(r).

8. The processing element of claim 1, wherein the processing element comprises a core of a multi-core processor, a core of a multi-core graphics processing unit, an accelerator, or a field programmable gate array.

9. At least one machine readable medium comprising a plurality of instructions that in response to being executed by a processing element causes the processing element to:
load a shared representation of a value x to a register file, wherein the shared representation is based on n shares, where n is greater than or equal to 2;
cause the shared representation of the value x to be input to an arithmetic logic unit (ALU) from the register file;
cause, at the ALU, an operation using the shared representation of the value x to generate a shared representation of a value y result; and
cause the shared representation of the value y result to be stored to n registers from among a plurality of registers or cause single representation of the value y result to be stored to a register from among the plurality of registers.

10. The at least one machine readable medium of claim 9, wherein the operation using the shared representation of the value x to generate the shared representation of the value y result comprises a cryptographic operation, and wherein the value x is a secret key and the shared representation of the value y result is a cryptographic signature.

11. The at least one machine readable medium of claim 9, wherein the shared representation of the value x is loaded from n registers from among the plurality of registers.

12. The at least one machine readable medium of claim 9, wherein the instructions are to further cause the processing element to:
convert the value x to the shared representation of the value x prior to loading the shared representation of the value x to the register file.

13. The at least one machine readable medium of claim 9, comprising the shared representation of the value x has separate m-bit integer values of z that are to be casted to separate floating point representations f, where m is any whole, positive number, wherein the instructions are to further cause the processing element to:
obtain a random number r to be generated such that z+r is greater than 0; and
determine the separate floating point representations f based on float(z+r)−f−float(r).

14. A system comprising:
a plurality of processing elements, wherein at least one of the processing elements includes:
a plurality of registers, at least one register of the plurality of registers configured to store a value x;
an arithmetic logic unit (ALU); and
circuitry configured to:
load a shared representation of the value x to a register file, wherein the shared representation is based on n shares, where n is greater than or equal to 2;
cause the shared representation of the value x to be input to the ALU from the register file;
cause, at the ALU, the shared representation of the value x to be recombined to a single representation of the value x;
cause, at the ALU, an operation using the single representation of the value x to generate a value y result;
cause, at the ALU, the value y result to be split to a shared representation based on n shares; and
cause the shared representation of the value y result to be stored to n registers from among the plurality of registers or cause a single representation of the value y result to be stored to a register from among the plurality of registers.

15. The system of claim 14, wherein the operation using the single representation of the value x to generate a value y result comprises a cryptographic operation, and wherein the value x is a secret key and the value y result is a cryptographic signature.

16. The system of claim 14, the shared representation of the value x comprises n Boolean shares, wherein the shared representation of the value x to be recombined to the single representation of the value x is via an n operand XOR result generated based on the n Boolean shares.

17. The system of claim 14, the shared representation of the value x comprises n arithmetic shares, wherein the shared representation of the value x to be recombined to the single representation of the value x is via an n operand addition result generated based on the n arithmetic shares.

18. The system of claim 14, wherein the shared representation of the value x is loaded from n registers from among the plurality of registers.

19. The system of claim 14, wherein the circuitry is further configured to:
convert the value x to the shared representation of the value x prior to loading the shared representation of the value x to the register file.

20. The system of claim 14, comprising the single representation of the value x has an m-bit integer value of z that is to be casted to a floating point representation f, where m is any whole, positive number, wherein the circuitry is further configured to:
obtain a random number r to be generated such that z+r is greater than 0; and
determine the floating point representation f based on float(z+r)−f−float(r).
